(19) United States
(12) Patent Application Publication
(10) Pub. No.: US 2011/0022450 A1
(43) Pub. Date: Jan. 27, 2011

(54) COMPTUER NETWORK CHAT SYSTEM FOR DISPLAY OF TEXT AND VIDEO IN A RIVALRY CONTEXT

(75) Inventor: MATTHEW B. MEREDITH, EULESS, TX (US)

Correspondence Address: HOWISON & ARNOTT, L.L.P, P.O. BOX 741715, DALLAS, TX, 75374-1715, US

(73) Assignee: RIVALROO, INC., IRVING, TX (US)

(21) Appl. No.: 12/841,005

(22) Filed: Jul. 21, 2010

Related U.S. Application Data
(60) Provisional application No. 61/227,346, filed on Jul. 21, 2009.
(60) Provisional application No. 61/305,467, filed on Feb. 17, 2010.
(60) Provisional application No. 61/351,070, filed on Jun. 3, 2010.

(51) Int. Cl. G06F 3/01; G06Q 30/00

(52) U.S. Cl. 705/14.4; 715/758

(57) ABSTRACT

A chat system comprises a chat room application (Team Chat application) running on a chat server connected to a computer network having a plurality of users. The Team Chat application is configured to produce a chat room interface on the display of users accessing the chat room site. The chat room interface includes a central chat display area flanked on either side by two lists of users identifying themselves in support of one of the two sides of a rivalry (e.g., team A or team B). Once a user is logged in and identifies which team (i.e., side of the rivalry) they support (e.g., either team A or team B), the user and other users affiliated with that team will be represented on one side of the central chat display area (e.g., the left side), and the users affiliated with the rival team will be represented on the other side of the central chat display area (e.g., on the right side). Users cannot participate in the chat until they log in and identify which side of the rivalry they support. If not logged in, the user cannot participate, but the central chat display area is still visible and updated.

### CROSS-REFERENCE TO RELATED APPLICATIONS

This application claims benefit to U.S. Provisional Application No. 61/227,346, titled COMPUTER NETWORK CHAT SYSTEM FOR SIMULTANEOUS DISPLAY OF MULTIPLE TEXT CHANNELS IN A RIVALRY CONTEXT, filed on Jul. 21, 2009; U.S. Provisional Application No. 61/305,467, titled COMPUTER NETWORK CHAT SYSTEM FOR DISPLAY OF MULTIPLE TEXT CHANNELS IN A RIVALRY CONTEXT, filed Feb. 17, 2010; and U.S. Provisional Application No. 61/351,070, titled COMPUTER NETWORK CHAT SYSTEM FOR DISPLAY OF TEXT AND VIDEO IN A RIVALRY CONTEXT, filed Jun. 3, 2010.

### TECHNICAL FIELD

The following disclosure relates to messaging systems for computer networks. More particularly, it relates to so-called “chat room” applications that allow the display of real time or near-real time text communications between multiple users on a computer network such as the Internet. It further relates to chat room applications that allow the display of text and/or video in the context of a rivalry between two groups.

### BACKGROUND

One popular feature of wide area computer networks such as the Internet is a type of network communication application known as a “chat room.” Generally speaking, a chat room is a network site that allows multiple users of the computer network to register, i.e., “log on” or “sign in,” to the site and then simultaneously input text material intended to be conversational in nature. The text input from, e.g., a first user is immediately relayed to the computers of the other users who also happen to be logged onto the same chat room at that time, such that the text from the first user is presented to the other users in real time, or near real time. The other users logged onto the same chat room may then respond, if desired, by inputting text material of their own, and their text material is likewise relayed to the other “occupants” of the chat room, including the first user. In this way, computer users across the network can maintain a conversation or dialogue with each other in real time or near real time. In some chat room applications, users may be permitted to view the site without logging on, thus having access to the text content without contributing to it. Such users may be considered “spectator” users, whereas the users registered to input text may be considered “participant” users.

In some cases, a single chat room application or site may host a number of independent conversations, typically known as “channels” or “rooms.” In such cases, a user will first select a channel/room of interest from a list of available channels/rooms. Then the user will “join” the selected channel/room to begin accessing the text conversation, which are conducted as described above.

It is known to use the chat room format to promote enthusiasm or loyalty to specific institutions, for example, sports teams. In many cases professional teams, universities, schools, or even sports fans themselves will create a chat room site dedicated to discussing and supporting a specific team. It will be appreciated that many teams have historic “rivals,” i.e., opposing teams that have been played over a long period of time that fans are particularly interested in. Further, there are some major games, such as so-called “bowl games,” that are of particular importance to fans. When a favorite team is scheduled to play a traditional rival in a bowl game or other significant game, the conversation volume on sports-team related chat room sites can become high.

One popular activity on sports-related sites or other sites promoting opposing viewpoints, loyalties or affiliations (i.e., rivalries) is bragging about the user's favored team. A need therefore exists, for a chat room application that facilitates the display of text communications in a rivalry context.

A related activity is so-called “smack talk,” i.e., the art of belittling an opposing team (and/or its supporters) in the face of impending competition between the favored team and the opposing team. To be most satisfying, however, many users feel that the bragging and smack-talking should be practiced in the direct presence of the rivals. A need therefore exists, for a chat room application that facilitates bragging and smack-talking by one user group (e.g., of sports fans) in the presence of another user group representing a rival group (e.g., of sports fans), and vice versa.

It is known to view video clips via a computer network. In some cases, the video clips are embedded within other content, e.g., on a web page. However, video clips are typically categorized and accessed with respect to affiliation with a single group, rather than with respect to a rivalry between multiple groups. A need therefore exists, for a chat room application that facilitates both text communications in a rivalry context and the viewing of video clips relevant to the subject rivalry.

### SUMMARY

In one aspect thereof, a chat system is provided for a computer network having a plurality of users, at least some of the users having a first of two rival affiliations and at least some of the other users having a second of the two rival affiliations. The chat system comprises a chat room application (also known as a Team Chat Application) running on a chat server computer connected to the computer network. The Team Chat application is configured to produce a chat room interface on the display of each of the plurality of users accessing the chat room site. The chat room interface includes a dual channel simultaneous display area including a first channel showing a text chat conversation among users having the first of the two rival affiliations and a second channel showing a text chat conversation among users having the second of the two rival affiliations. The Team Chat application allows all users accessing the site to simultaneously view the first and second channels, but only users logged in as having the first of the two rival affiliations can input text on the first channel, and only users logged in as having the second of the two rival affiliations can input text on the second channel.

In another aspect thereof, a chat room interface includes a central chat display area flanked on either side by two lists of users identifying themselves in support of one of the two sides of a rivalry (e.g., team A or team B). When not logged in, the left and right placement of the teams is arbitrary. Once a user is logged in and identifies which team (i.e., side of the rivalry) they support (e.g., either team A or team B), the user and other users affiliated with that team will be represented on one side of the central chat display area (e.g., the left side), and the users affiliated with the rival team will be represented on the other side of the central chat display area (e.g., on the right side). Users cannot participate in the chat until they log in and identify which side of the rivalry they support. If not logged in, the user cannot participate, but the central chat display area is still visible and updated.

In a further aspect thereof, a chat system further comprises an advertising server connected to the computer network. The advertising server provides advertising content for display on selected areas of the chat room interface by the Team Chat application.

In yet another aspect thereof, software is provided for a chat system having a rivalry context in accordance with the accompanying disclosure.

In still another aspect thereof, a method is provided for conducting a chat session in a rivalry context in accordance with the accompanying disclosure.

### BRIEF DESCRIPTION OF THE DRAWINGS

For a more complete understanding, reference is now made to the following description taken in conjunction with the accompanying Drawings in which:

FIG. 1 illustrates a computer network chat system in accordance with one aspect operating over the Internet;

FIG. 2 illustrates a rivalry-context chat room interface in accordance with another aspect;

FIG. 3 shows an example of the chat room interface of FIG. 2 customized for the rivalry between the University of Texas and the University of Oklahoma;

FIG. 4 illustrates a rivalry-context chat room interface in accordance with yet another embodiment;

FIG. 5 shows an example of the chat room system interface of FIG. 4 customized for the rivalry between the University of Texas and the University of Oklahoma;

FIG. 6 illustrates a rivalry-context chat room system interface in accordance with another embodiment, shown in a first mode in accordance with one aspect;

FIG. 7 shows a partial view of the system interface of FIG. 6, showing a drop-down submenu in accordance with another aspect;

FIG. 8 illustrates the interface of FIG. 6, shown in a second mode in accordance with another aspect;

FIG. 9 illustrates a team card for a chat room interface in accordance with another embodiment;

FIG. 10 illustrates an account settings page for a chat room system in accordance with another embodiment;

FIG. 11 shows an enlarged view of the main chat text display area (i.e., “Blast Box”) in accordance with another aspect;

FIG. 12A illustrates a HOME PAGE interface of a rivalry-context chat room system in accordance with yet another embodiment, which interface is shown in league display mode;

FIG. 12B illustrates the HOME PAGE interface of FIG. 12A in an alternative display mode;

FIG. 13 shows the chat room system interface with the “BLAST BOX” tab selected in accordance with another aspect of the system of FIG. 12;

FIG. 14A shows the chat room system interface of FIG. 13 with the “PREVIEW” tab selected in accordance with another aspect;

FIG. 14B is an enlarged view of the chat room system interface of FIG. 14A, showing a drop down menu;

FIG. 15 shows the chat room system interface of FIG. 13 with the “VIDEO” tab selected in accordance with another aspect;

FIG. 16 depicts a flow chart for creating a user account;

FIG. 17 is an exemplary create account modal;

FIG. 18 is another exemplary create account modal;

FIG. 19 depicts a modal for either creating an account or using a third-party login account to sign into an exemplary Blast Box chat application;

FIG. 20 depicts various exemplary selector header graphic interface areas of an exemplary Blast Box chat application;

FIG. 21 depicts an exemplary graphic use interface page organizational chart; and

FIG. 22 depicts a chat area portion wherein the @username chat function is being used.

### DETAILED DESCRIPTION

Referring now to the drawings, wherein like reference numbers are used herein to designate like elements throughout, the various views and embodiments of a computer network chat system for display of text and video in a rivalry context are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

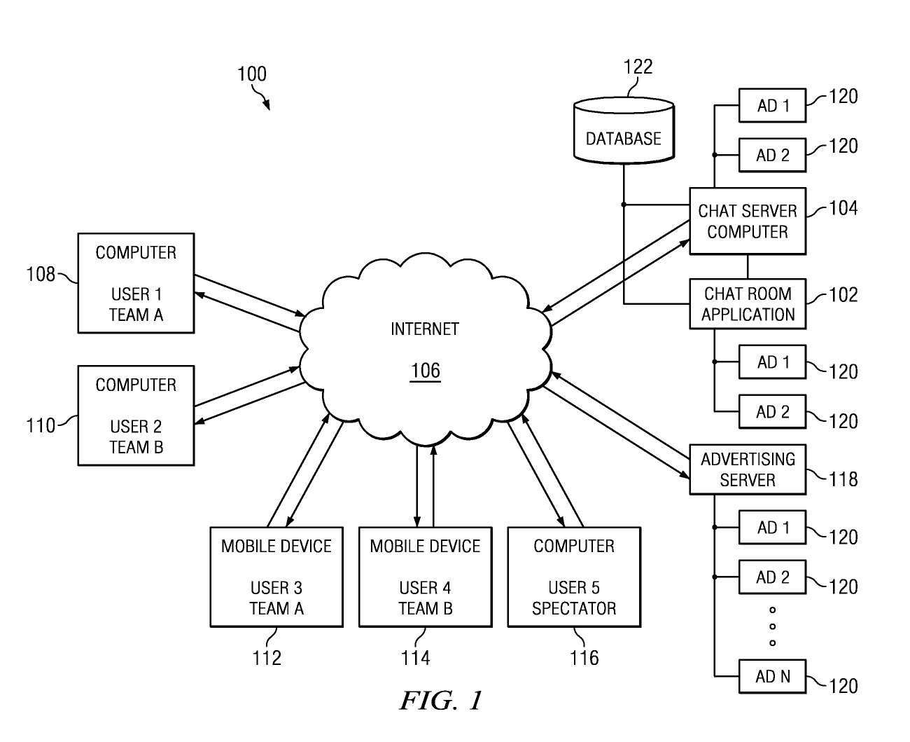

Referring now to FIG. 1, there is illustrated a computer network chat system in accordance with one aspect operating over the Internet. The chat system 100 comprises a chat room application 102 (also know as a Team Chat application) operating on a chat server computer 104 that is connected to a computer network 106. In this example, the computer network 106 is the Internet; however, it will be appreciated that the chat system 100 may be implemented on any computer network. The Team Chat application 102 is software utilizing known chat room protocols such as Internet Relay Chat (“IRC”) or other known protocols for synchronous or asynchronous network text conferencing.

Referring still to FIG. 1, the chat system 100 allows a plurality of users 108, 110, 112, 114 and 116 having different rivalry affiliations to log in to a common Team Chat application on the computer network 106 and conduct text conversations using network browser software and/or client software provided by the chat server 104. For purposes of example in FIG. 1, it is assumed that a rivalry exists between fictional “Team A” and fictional “Team B.” The users in FIG. 1 are thus divided between those affiliated with Team A (e.g., users 108, 112), those affiliated with Team B (e.g., users 110, 114) and those who are as yet unaffiliated (e.g., user 116). The users 108-116 may connect to the chat server 104 using any type of network device, including computers, netbooks, smartphones, iPhone® brand mobile devices, Blackberry® brand mobile devices or any other web-enabled devices. Once connected to the chat server 104, the users 108-116 will be presented with a chat room displaying one or more text channels in a rivalry context as further described below.

In some embodiments, the chat system 100 may be adapted to cooperate with one or more advertising applications 120 to generate and display advertising content (“ads”) along with the text channels delivered to the users 108-116 by the chat system. In some embodiments, the advertising applications 120 may be components of the Team Chat application 102 itself, whereas in other embodiments, the Team Chat application 102 is merely configurable to interact with external adverting applications. The resulting advertising content may be juxtaposed with the text channels on the user's display screen, inserted into the text channels themselves and/or displayed in a different manner. In various embodiments, the advertising applications 120 may be elements of the Team Chat application 102 itself, external applications stored on the chat room server 104 and/or external applications stored on an advertising server 118 connected to network 106. In the illustrated example, some advertising applications 120 are components of the Team Chat application 102, others are external applications residing on the chat server 104, and still others are external applications residing on an advertising server 118. In the illustrated example, the advertising server 118 is a separate computer from the chat server 104, however, in other examples, the same computer may function as both the chat server 104 and the advertising server 118. In still other examples, both internal and external advertising servers may be used.

The chat system 100 may further include one or more database 122 including data relating to rivalry contests (e.g., dates, teams, locations, statistics relating to previous contests, league affiliations, etc.), teams (e.g., names, mascots, logos, player names and positions, team statistics) and user (e.g., names, IDs, team affiliation selections, league affiliation selections, preferences, etc.). All such data may be stored in a single database 122, or multiple databases may be used, e.g., one for team data, one for user data, one for rivalry contests, etc. The database(s) 122 may be stored on a stand-alone computer/server (not shown) or they may be stored on the chat server computer 104. The Team Chat application 102 and/or the chat server 104 may access the data in the database to produce chat screen displays having a rivalry context as further described herein.

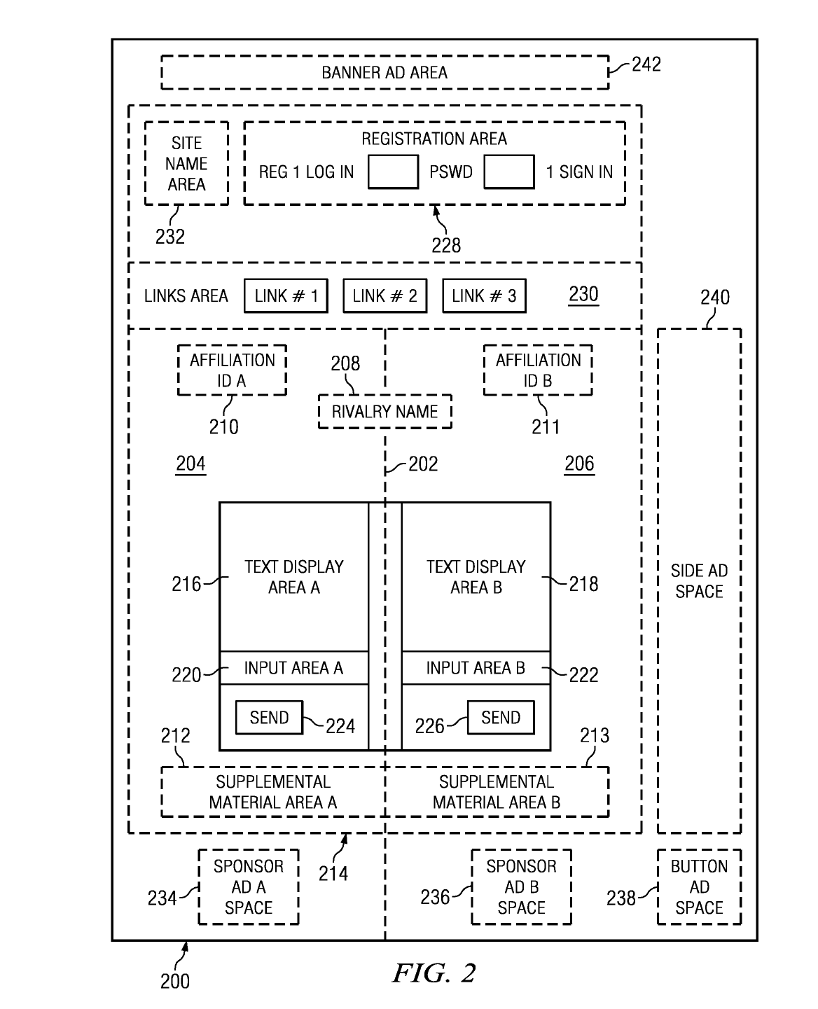

Referring now to FIG. 2, a computer network chat system in accordance with one embodiment produces a user display (Graphical User Interface or “GUI”) that simultaneously shows multiple text channels in a rivalry context, e.g., one text channel for each affiliation of the rivalry. As with FIG. 1, it is assumed for purposes of illustration that a rivalry exists between Team A and Team B. The chat room interface GUI 200 represents an image that may be viewed on the user's display screen using, e.g., a web browser, when connected to the chat system 100. It will be appreciated that the chat system 100 may present different interfaces 200 on different types of user devices, depending, for example, on the capabilities and resolution of the display. For example, the interface 200 illustrated in FIG. 2 may be viewed on a conventional computer screen, while a simplified interface image (not shown) may be presented on a user device having lower screen resolution such as a mobile phone.

Referring still to FIG. 2, the chat room interface 200 is configured in a rivalry context having a dividing line 202 that splits the display area into two sides, e.g., a first side (denoted 204) affiliated with Team A and a second side (denoted 206) affiliated with Team B. In a preferred embodiment, the rival sides 204 and 206 are presented in contrasting color schemes that are associated with their respective team colors, and the popular name of the rivalry may be displayed in a centrally-located name field 208. In other embodiments, an affiliation-specific ID or slogan may be provided in respective affiliation ID fields 210 and 211 disposed on each side of the dividing line 202. In still other embodiments, first and second supplemental material areas 212 and 213, respectively, may be provided on rival sides 204 and 206 for displaying additional affiliation-specific content such as photos, animation, graphics or text related to each respective team.

Spanning the dividing line 202 is a dual channel simultaneous display area 214 that includes a first text display area 216 disposed on first side 204 and a second text display area 218 disposed on second side 206. The first text area 216 will display the chat text from a first chat channel for users affiliated with Team A, and the second text area 218 will display the chat text from a second chat channel for users affiliated with Team B. The chat text from the first and second chat channels is simultaneously shown to all users (regardless of affiliation) currently visiting the subject chat room interface 200. First and second text input areas 220 and 222, and first and second SEND buttons 224 and 226, may be disposed on each side of the dual channel simultaneous display area 214 adjacent to the respective text display areas 216 and 218 to allow for text entry by users logged into the site.

Upon first reaching the chat room interface, all users (e.g., users 108-116) can view the dual channel simultaneous display area 214 including both conversation channels in rival text display areas 216 and 218. This allows all users to appreciate any comments, bragging or smack talk going on between users affiliated with the rival teams. Users having an affiliation to one team or the other may then utilize a registration area 228 to select their team affiliation and obtain a site login ID and password. In some embodiments, a third-party login application, such as a facebook connect API may provide a connect button in or about the registration area 228. A third-party login connect button may be pressed by a user to log into an exemplary chat interface using the login criteria for a third-party login application such as facebook. After a user obtains a team affiliation, login ID and password, that user can sign in to receive access to the respective text input area 220 or 222 for their affiliation. Note that only users affiliated with Team A can utilize the text input area 220 feeding text display area 216, whereas users affiliated with Team B must utilize the text input area 222 feeding text display area 218. Thus, each side of the 204, 206 of the simultaneous display area 214 displays a channel featuring a conversation among users having the same affiliation, however, all users can view both conversations simultaneously. By configuring the chat system interface 200 in a rivalry format, this simulates the separation between opposing fans often encountered in a stadium or arena during a “big game.” Thus, creative comments, virtual catcalls and smack talking are encouraged to increase fan enjoyment of the rivalry.

In some embodiments, the chat system interface 200 may further include a links area 230 providing hyperlinks to related information of possible interest, for example, game scores, game schedules, poll rankings, game coverage, news and headlines, team rosters, and archives. A site name area 232 may also be provided displaying the name, internet address, or other information regarding the particular chat site.

In another aspect, the chat system interface 200 includes one or more advertising locations disposed around the visible page. Some such advertising locations are affiliated with Team A or Team B, and therefore are disposed on the associated team side 204 or 206, e.g., locations 234 and 236, respectively. Other such advertising locations, e.g., button advertisement 238, sideline advertisement 240, and banner advertisement 242, may not be affiliated with a particular team, but may be of interest to users in general. In some aspects, the advertising locations 234-242 may display fixed or “static” advertisements, whereas in other aspects the advertising locations may display dynamic advertisements delivered from the advertising server 118 (FIG. 1). In the case of dynamic advertisements, the advertisements to be displayed may be chosen from the advertising server 118 from a plurality of available ads 120 depending on various factors such as user affiliation, user address, user history, cookies resident on the user's computer, or other user data that may be voluntarily provided by the user or obtained automatically by the chat system client software as part of the chat system 100. Each advertising location 234-242, whether featuring static or dynamic advertising content, may include one or more embedded links that, if clicked, redirect the user to other network sites selected by the chat system 100. It will be appreciated that the advertising aspects described in association with the chat systems of FIGS. 1 and 2 are also applicable to the other new chat systems described herein.

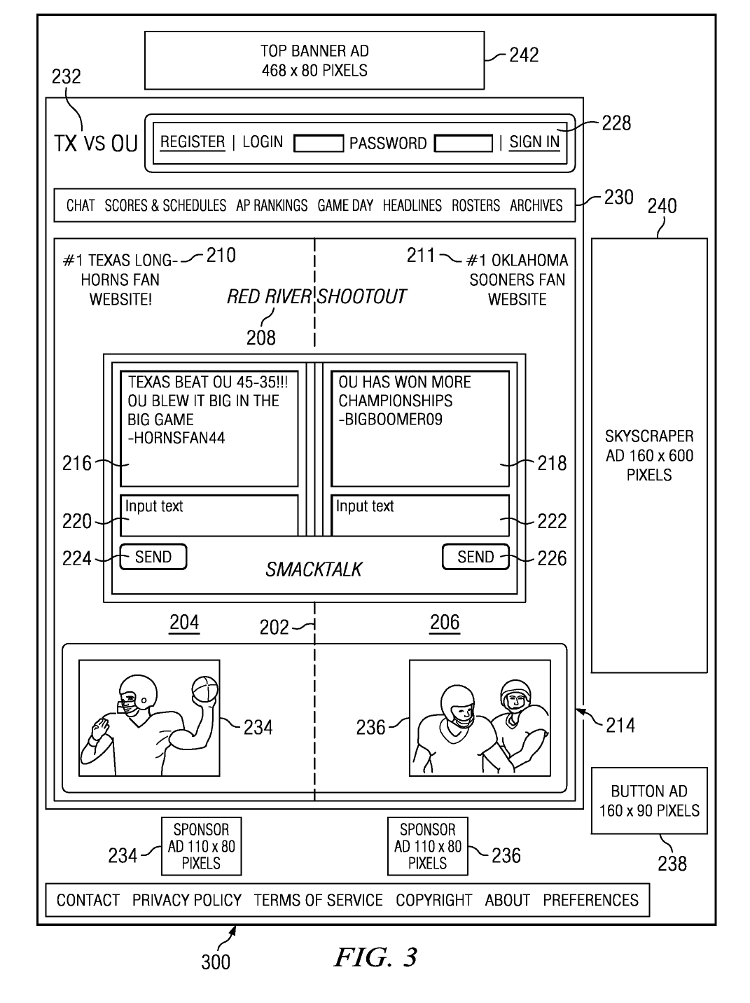

Referring now to FIG. 3, there is illustrated an example of a chat room interface 300 configured for the well-known Texas vs. OU rivalry (i.e., the University of Texas vs. the University of Oklahoma). The specific features of the interface 300 are denoted using the same reference numbers described in FIG. 2.

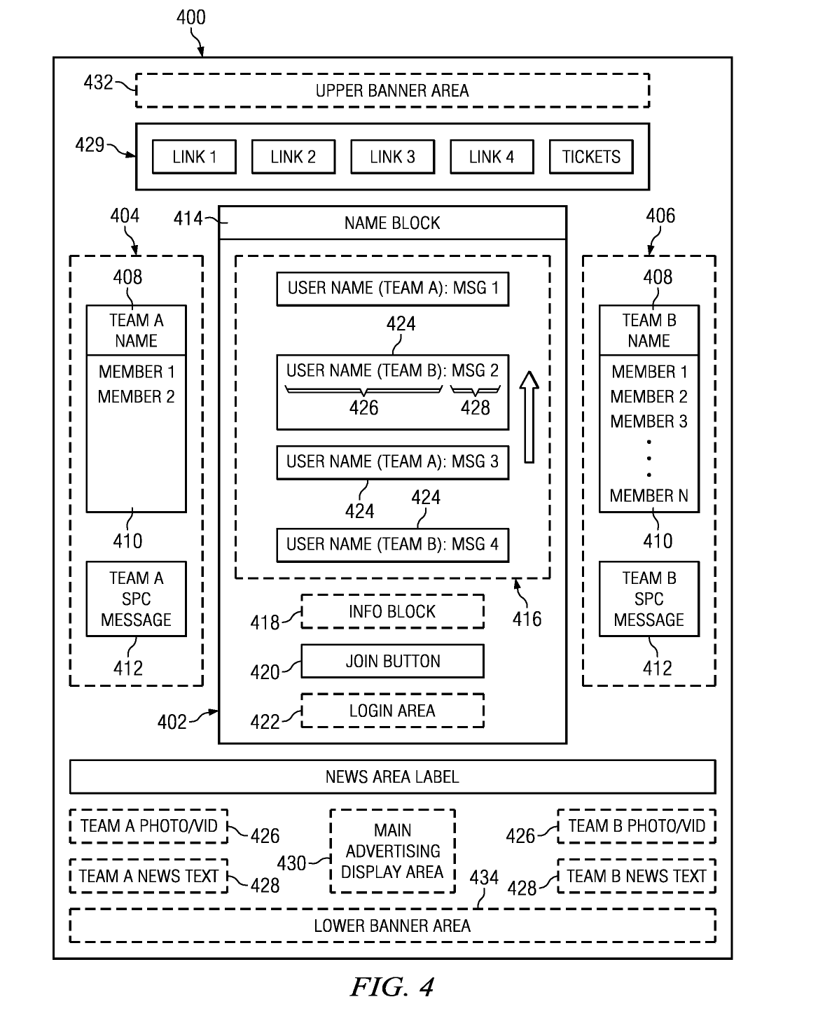

Referring now to FIG. 4, a computer network chat system in accordance with another embodiment produces a user display that shows one or more text channels in a rivalry-specific context. As with FIG. 1, it is assumed for purposes of illustration that a rivalry exists between Team A and Team B (e.g., the “Team A vs. Team B rivalry”). The chat room interface 400 represents an image that may be viewed on the user's display screen using, e.g., a web browser, when connected to the chat system 100. As with previously described interface 200, it will be appreciated that the chat system 100 may present different interfaces 400 on different types of user devices, depending, for example, on the capabilities and resolution of the display.

Referring still to FIG. 4, the chat room interface 400 is configured in a rivalry context having, in this example, a single main display area 402 disposed substantially along the centerline of the display, a left sidebar 404 disposed to the left of the main display area and a right sidebar 406 disposed to the right of the main display area. The left sidebar 404 is associated with one affiliation of the rivalry (e.g., Team A) and the right sidebar 406 is associated with the other affiliation of the rivalry (e.g., Team B). Each sidebar 404, 406 includes a team name area 408, roster area 410 and team-specific message area 412 for its respective team.

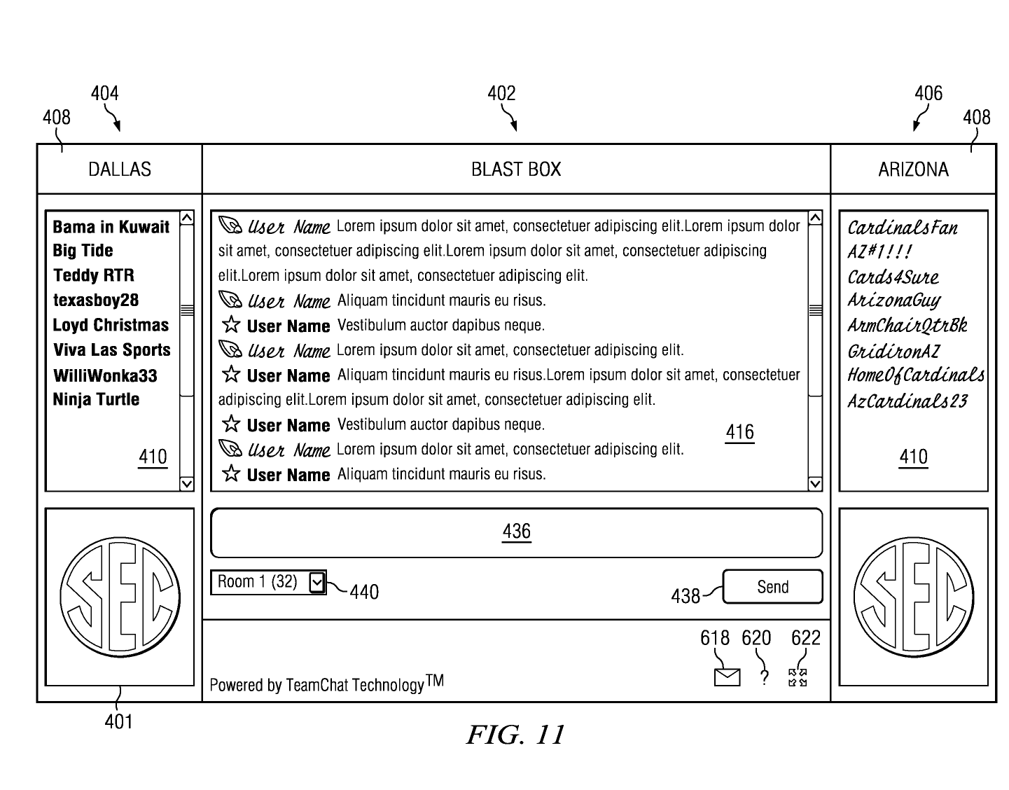

Referring still to FIG. 4, and now also to FIG. 11, the chat room interface 400 is configured in a rivalry context having, in this example, a unified central chat display area 402 (which may be termed a “Blast Box”) disposed substantially along the centerline of the display, a left sidebar 404 disposed to the left of the central chat display area and a right sidebar 406 disposed to the right of the central chat display area. The Blast Box 402 is a conversation tool that allows users to chat from a sports rivalry context while giving immediate information to a viewer as to which logged-in user is affiliated with which team. The left sidebar 404 is associated with one affiliation of the rivalry (e.g., Team A) and the right sidebar 406 is associated with the other affiliation of the rivalry (e.g., Team B). Each sidebar 404, 406 includes a team name area 408, roster area 410 and team-specific message area 412 for its respective team. FIG. 11 provides a chat room interface 401 that comprises a Blast Box 402 in a user selected full screen mode wherein the Blast Box 402 fills a majority of the user's display screen.

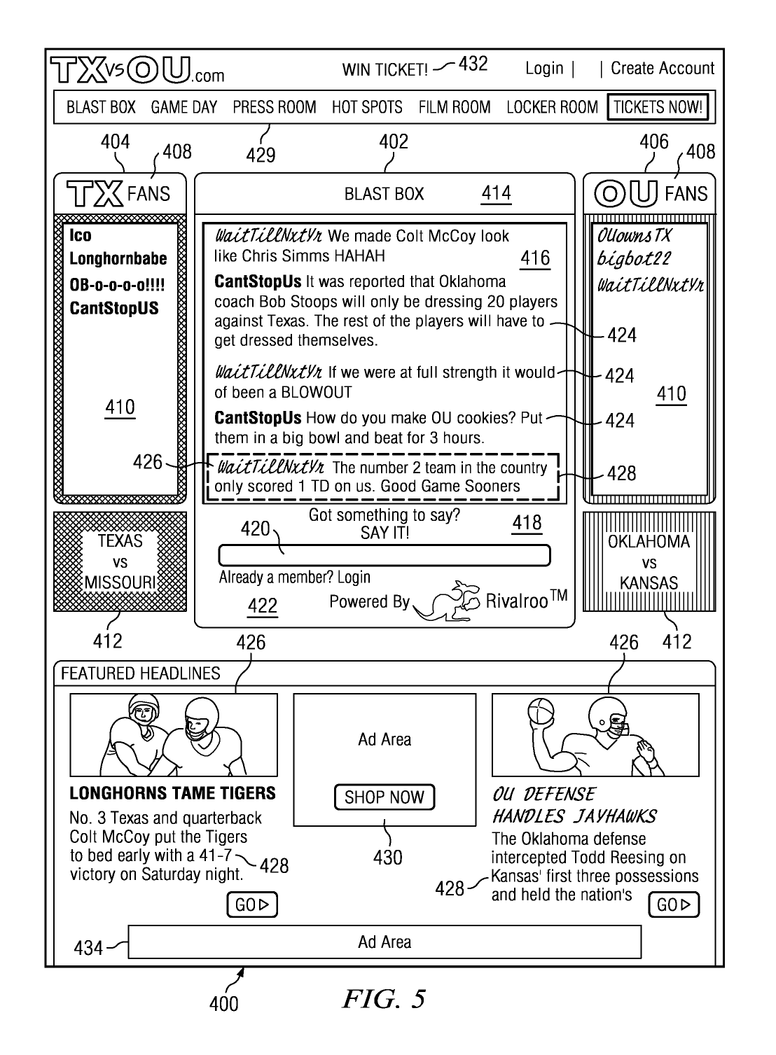

The respective roster area 410 display those users that are currently logged-in for each affiliation, i.e., those logged-in users affiliated with Team A are shown in the left roster area 410, and those logged-in users affiliated with Team B are shown in the right roster area 410. Users that do not have an affiliation with Team A or Team B (e.g., users affiliated with other rivalries) may not be listed in either roster area, and may not be allowed to participate in the chat (other than as a spectator). In an exemplary embodiment (see e.g., FIG. 5), the text color and/or color theme used for each sidebar 404, 406 will be selected to be representative of the team/affiliation associated with that sidebar.

The team-specific message areas 412 may be used to provide team-specific information, e.g., listings of upcoming contest involving the respective team/affiliation, special notices relating to the respective team/affiliation, advertising, etc. relating to the respective team/affiliation.

The central chat display area 402 may include a name block 414, scrolling text display area 416, invitation block 418, “JOIN” button 420 and “LOGIN” area 422. The scrolling text display area 416 displays chat text messages 424 from the logged-in users of both affiliations, i.e., those users listed in the roster areas 410 of each sidebar 404, 406. Each chat text message 424 may include a user name portion 426 and a message portion 428. In game embodiments (see e.g., FIG. 5), the text color of the user name portion 426 of each message 424 will be selected to be representative of the team/affiliation associated with the respective user. In some embodiments, each text message 424 may be preceded by the logged-in user's screen name, displayed in the team's color along with the team's logo. By displaying each chat text message 424 in this manner, a viewer or user may immediately recognize which team the user supports.

After the user logs in to the chat system, the invitation block 418, “JOIN” button 420 and “LOGIN” area 422 may no longer be needed and may be replaced by features that facilitate entry of chat text. In one embodiment shown in FIG. 11, after login the invitation block 418, “JOIN” button 420 and “LOGIN” area 422 are replaced with a chat message text entry area 436, a “SEND” button 438 and a chat room (i.e., session) selector 440. The user may type the desired text for a message in the chat message text entry area 436. The user can view and edit the text in the text entry area 436, however, the text is not visible to other participants in the chat session until the user presses the “SEND” button 438. Once the “SEND” button 438 is pressed, the text in the text entry area 436 is broadcast to the scrolling text display area 416 on the screens of all participants (i.e., users and spectators) of that chat room/session.

In some embodiments, the chat system controls the display order of the successive chat text messages 424 shown in the scrolling text display area 416 such that successive chat text messages are from users having alternating affiliations. For example, if the first chat message displayed is from a user affiliated with Team A, the second chat message displayed may be from a user affiliated with Team B, then the third chat message displayed may again be from a user affiliated with Team A (either the same user as the first message, or a different user), then the fourth chat message displayed may be from a user affiliated with Team B (either the same user as the second message, or a different user), and so on. In other cases, the chat system does not require all successive text messages 424 to have alternating team affiliation.

Referring again to FIG. 1, as well as to FIG. 4, in a chat room system having a chat room interface 400, all participants (e.g., users 108-116) can view the central scrolling text display area 416 to see and appreciate any comments, bragging or smack-talk going on between users affiliated with the rival teams. Users having an affiliation to one team or the other may then utilize the “JOIN” button 420 and login registration area 422 to select their team affiliation and obtain a site login ID and password. After a user obtains a team affiliation, login ID and password, that user can sign in (i.e., login) to be affiliated with one of the rival teams and placed in the respective roster area 410.

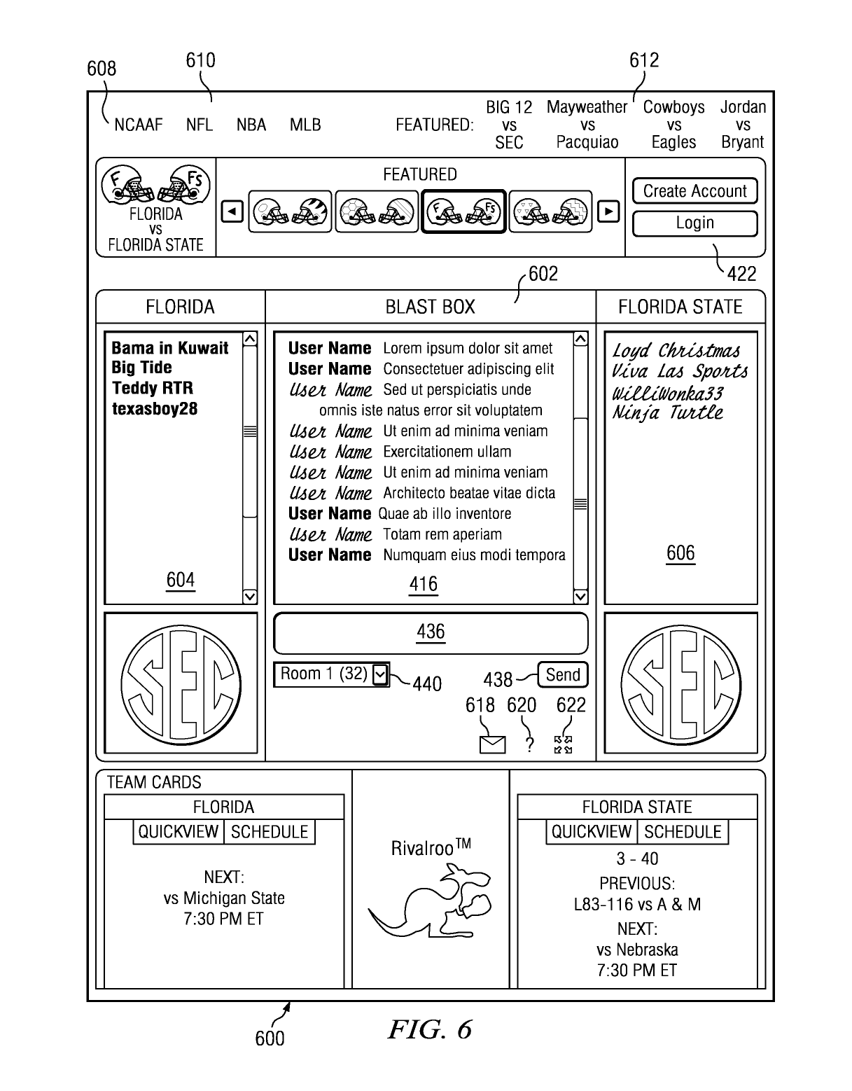

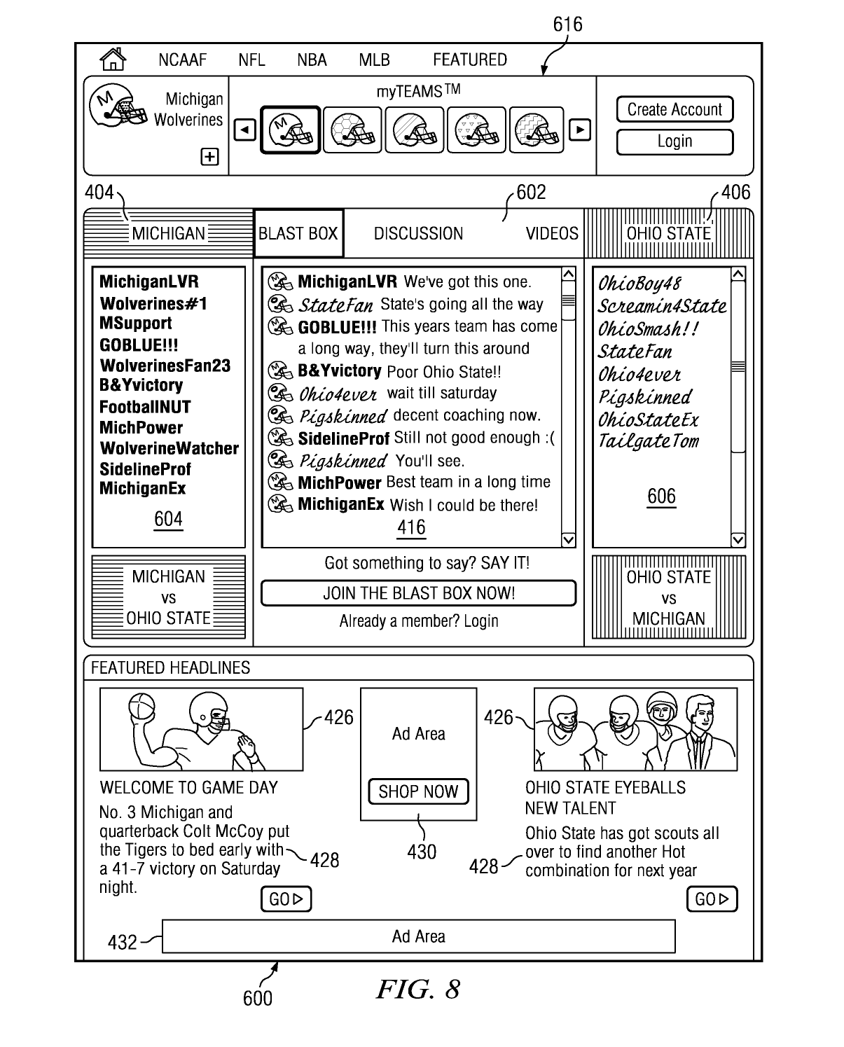

In another aspect, during registration each user may select one or more teams/affiliations from a plurality of available teams/affiliations provided. The selected team(s)/affiliation(s) are then designated as “favorites” or “myTEAMS” in the user's registration data, e.g., data stored in the Team Chat application 102, server 104 or database 122. When that user subsequently logs in to the chat system, the user's favorite/myTEAMS data may be used to enhance the user's experience and/or interaction with the chat system. For example, the default navigation panel (e.g., panel 608 in FIG. 6) displaying operator-selected teams and rivalries may be replaced or supplemented with a customized navigation panel (e.g., “myTEAMS” panel 616 in FIG. 8) displaying teams and rivalries corresponding to the teams/affiliations previously selected by the user. In some embodiments, when the user logs in to the chat system, the user will remain on the page (i.e., in the particular chat room) that the user was in when he/she decided to log in. However, the favorites data may be used by the chat system to determine the user's desired team/affiliation so as to correctly assign the user to one side or the other of the particular rivalry for chat purposes. In other embodiments, the favorites data may be used to quickly select a rivalry chat room to join when the user merely designates a sport or league. For example, if the user has previously designated the team “Dallas Cowboys” (a member of the NFL league) as a favorite, then when the league “NFL” is selected in the navigation panel, the user may be automatically directed to the current rivalry involving the Dallas Cowboys team, without having to select “Dallas Cowboys” from a submenu. It will be appreciated, however, that users may be allowed to join any chat room on the chat system even if the teams involved in the particular chat room are not in the favorites/myTEAMS data for that user.

In some embodiments, the chat system interface 400 may further include a team/affiliation-specific photo and/or video area 426 and/or a team/affiliation-specific text news area 428 for each respective affiliation. Such photo/video area 426 and text news area 428 are preferably placed below the respective team sidebars 404, 406. In other embodiments, a menu bar area 429 may be provided to provide links (e.g., hyperlinks) to other network locations (whether on the chat server computer 104 or on other computers) containing information or features of possible interest to the user, for example, game scores, game schedules, poll rankings, game coverage, news and headlines, team rosters, and archives.

In another aspect, the chat system interface 400 includes one or more advertising locations disposed around the visible page. Some such advertising locations are affiliated with Team A or Team B, and therefore are disposed on the associated team side. Other such advertising locations, e.g., main advertising display area 430, upper banner advertisement 432 and lower banner advertising area 434 may not be specifically directed to a particular team/affiliation, but may be of interest to users in general. In some aspects, the advertising locations 430, 432, 434 may display fixed or “static” advertisements, whereas in other aspects the advertising locations may display dynamic advertisements delivered from the advertising server 118 (FIG. 1). In the case of dynamic advertisements, the advertisements to be displayed may be chosen from the advertising server 118 from a plurality of available ads applications 120 depending on various factors such as user affiliation, user address, user history, cookies resident on the user's computer, or other user data that may be voluntarily provided by the user or obtained automatically by the chat system client software as part of the chat system 100. Each advertising location 430, 432, 434, whether featuring static or dynamic advertising content, may include one or more embedded links that, if clicked, redirect the user to other network sites selected by the chat system 100.

Referring now to FIG. 5, there is illustrated an example of a chat room interface 500 configured for the well-known rivalry between the Texas vs. OU. The specific features of the interface 500 are denoted using the same reference numbers described in FIG. 4.

Referring now to FIGS. 6-10, there is illustrated a computer network chat system in accordance with yet another embodiment. The network communication protocols and “back end” structure of the alternative system may be similar to those of the systems previously disclosed herein, however, the user interface and “front end” structure is adapted to support users having multiple rivalry affiliations (e.g., favorite sports teams) in different rivalry groups (e.g., different sports or sports leagues).

The alternative chat room system generates a chat room interface screen 600 having a unified central chat display area (e.g., “Blast Box”) format similar to that previously disclosed in connection with FIGS. 4 and 5. A single central chat display area/Blast Box 602 is disposed substantially along the centerline of the display, a left sidebar 604 is disposed to the left of the central chat display area and a right sidebar 606 is disposed to the right of the central chat display. In this embodiment, however, the system is capable of generating multiple different Blast Box screens having different affiliation groups (e.g., different sports, or different leagues within sports) which the user may access according to pre-selected affiliations.

Referring now specifically to FIG. 6, the interface screen 600 is shown in a first mode (e.g., “sign-in” mode), as may be displayed to a new user or to an existing user that has not yet signed-in. A main navigation panel 608 (which may be called a “selector header” in some embodiments) may be displayed to assist the user in choosing a rivalry to view. In the embodiment shown, the main navigation panel 608 includes two sections, an affiliation group (e.g., sports league) section 610 and a featured rivalry section 612. The user may select any of the affiliation groups in section 610 or featured rivalries in section 612 by, e.g., clicking the desired name. In some embodiments, the selector header or main navigation panel 608 is a multi-purpose tool bar that appears generally near the top of an exemplary interface page 600. The purpose of the main navigation panel 608 is to provide an easy visual navigation to a user by displaying image/links of teams preselected by the user in the user's myTEAMS list. Users who are not logged-in may see image links of preselected featured match ups in the main navigation panel 608. An exemplary main navigation panel 608 may also provide information to the user that is indicative of the team's page that the user is currently on (the current team), the current opponent of the current team and upcoming opponents.

The affiliation groups displayed in the affiliation group section 610 of the main navigation panel 608 are groups of teams that regularly engage in contests. In the example shown, the affiliation groups in section 610, namely, NCAAF, NFL, NBA and MLB, are sports leagues each comprising multiple teams that play against one another, namely, a college football league, a professional football league, a professional basketball league and a professional baseball league, respectively. In other embodiments, other affiliation groups comprising teams that engage in contests or competitive events against one another may be displayed.

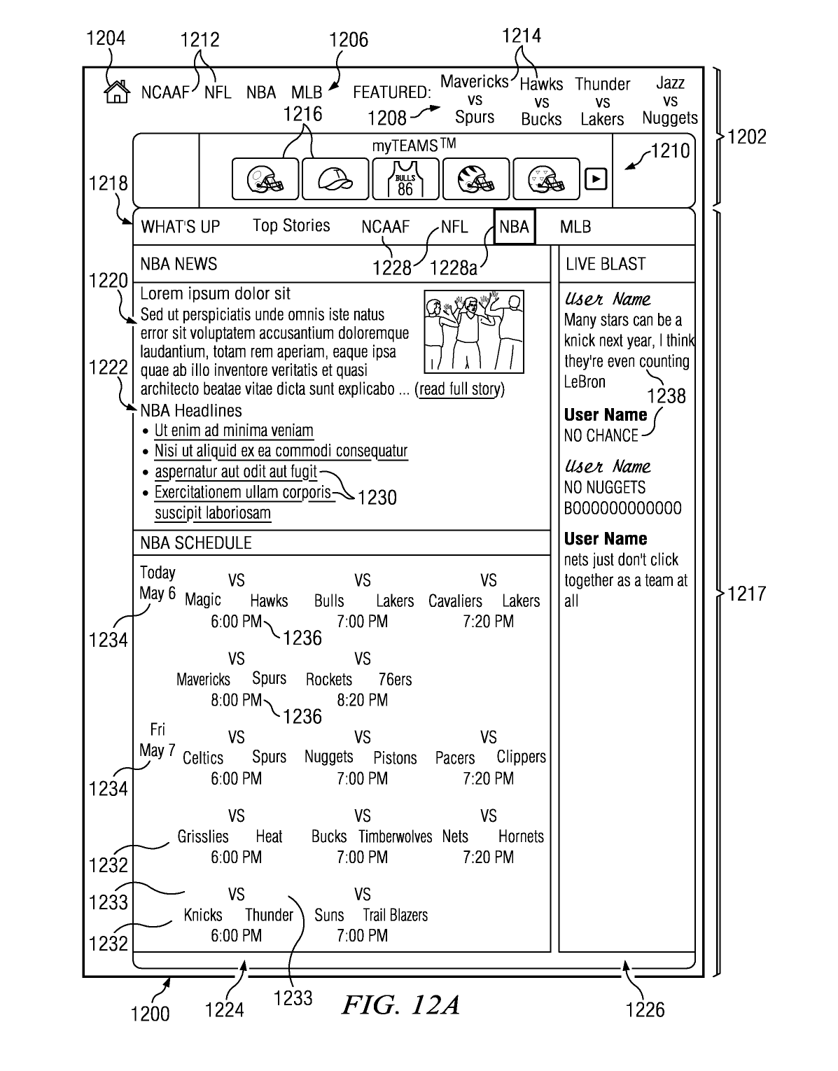

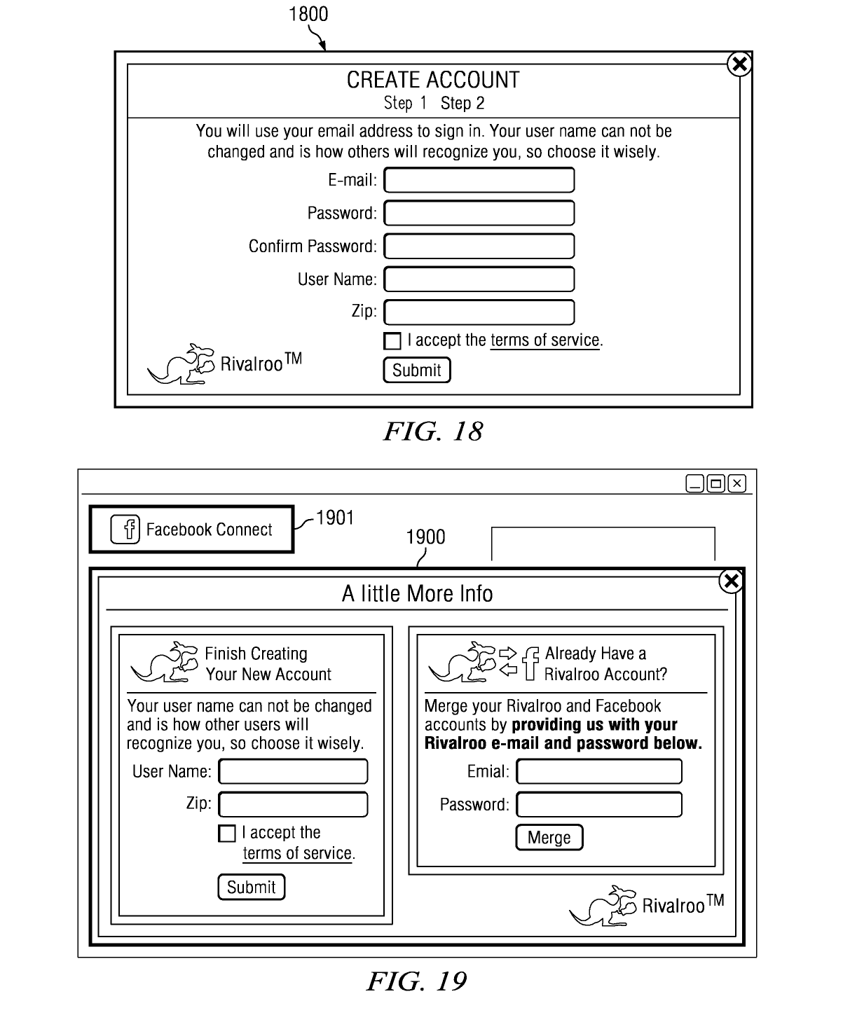

In some embodiments, the selector header 608 will look differently depending on whether a user is logged into an exemplary chat room interface 600, not logged-in, or if the user is logged-in and the selected team is in an off season time period. Referring to FIG. 20, three exemplary selector headers 608a, 608b and 608c are depicted. These selector headers may also be part of the header portion 1202 seen in FIG. 12a. Referring first to feature selector 608a, this feature selector may be displayed when a user is viewing an exemplary Blast Box interface but is not logged-in. A current team area 630 displays the currently selected team to the user. A current team may have been selected a number of ways. A current team may have been automatically selected via a third-party plug-in, selected by the user clicking on the team name within a navigation bar, selected from a featured selector icon within the featured selection area 612 or 632 or selected from the myTEAMS selector area 638. The current team's graphic or icon is shown in the current team area 630, along side text with the team's name and/or mascot. The featured selector area 632 shows the featured match ups to users who are not logged-in. The featured match up image-links 634 are user selectable areas that link to the featured Match Ups Blast Box. When hovered over, the images or icons may change from grayscale to full color indicating that they are active if clicked on. If clicked, a selector highlight 646 surrounds the box indicating that is has been selected. The current opponent area 636 depicts the next or current opponent that the current team is scheduled to play. An icon or graphic of the opposing team along with text of the teams name and perhaps a mascot will be displayed in this current opponent area 636 as well. For featured match ups, the current opponent area 636 will always be depicted on the right side of the selector area 608.

Referring to an exemplary selector header 608b, which may be depicted after a user is signed or logged-in, the myTEAMS selector area 638 shows a list of the user's previously selected teams from the user's myTEAMS list. The myTEAMS list is a list of the user's favorite teams to which the user may want to give regular attention. The myTEAMS image-links 640 or myTEAMS image icons are selectable icons or images that the user may click on to link to the teams Blast Box chat area. When hovered over, the myTEAMS image 640 may change from grayscale to full color indicating that it may be selected. If clicked or selected, the selector highlight 646 may appear about or behind the selected myTEAMS image link 640. If more teams have been selected as favorites by the user than can fit in the myTEAMS selector area 638, an arrow 648 may appear indicating that additional selectable teams are available. An upcoming opponents area 642 contains links to other Blast Box chat areas that the current team 630 is scheduled to play. Depicted in the exemplary upcoming opponents area 642 are three teams that are scheduled to play the selected team 630 in the near future. A date or date range may also be displayed with each one of the upcoming opponents in the area 642. Selecting one of the upcoming opponents will link the user to a Blast Box chat area between the current team and the selected upcoming opponent. Also, in some embodiments, an add additional teams button 644 may be depicted in the selected team area 630 so that a user may add the current team to the user's myTEAMS list.

Referring now to selector header 608c, which depicts a selector header that may be displayed when the selected team 630 is in an off season, here the selected team 631 is indicated as being selected by the selector highlight 646 being around the selected one of the myTEAMS image links 640. The team icon or logo is shown in the current team area 630. Since the selected team is in off season, an off season Blast Box label 650 is depicted indicating that the selected team is not scheduled to play another team in the near future.

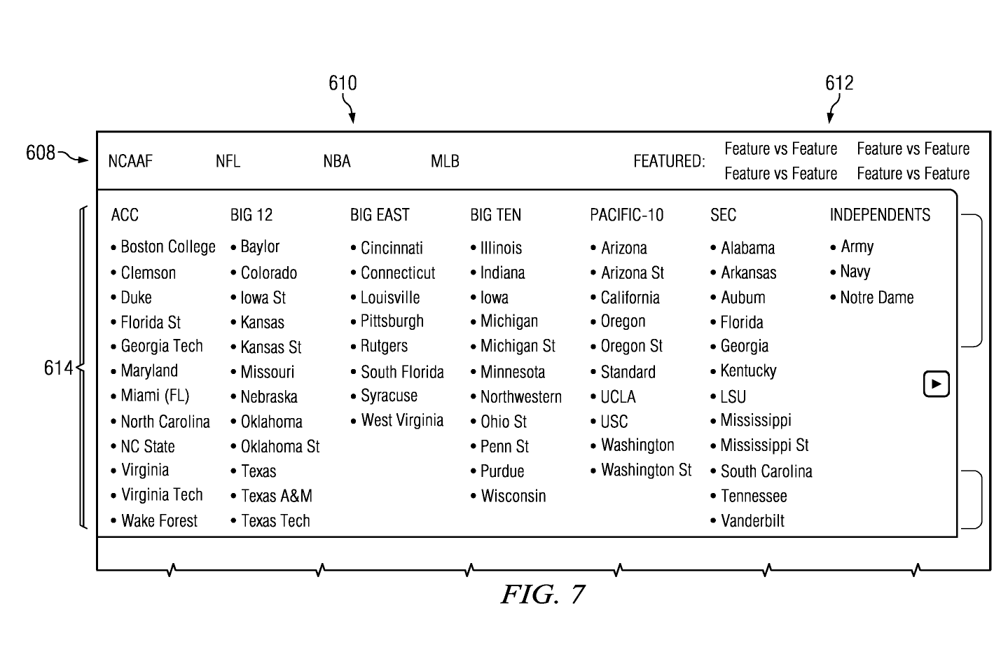

Referring now to FIG. 7, when the user selects one of the groups (e.g., a sports league) in affiliation group section 610 of the main navigation panel 608, a group submenu may be displayed providing a list of all the teams in that group, e.g., all the teams in that particular league or conference. In some embodiments, selecting the league/group may require clicking on the name of the league/group to display the submenu, while in other embodiments, merely placing the cursor over the name of the league/group (i.e., “hovering”) may cause the submenu to display. Submenus may also comprise multiple “views,” of which only one view is visible at a time. Switching between views may be accomplished by activating different selectors (e.g., buttons or arrows) on the menu or submenu. In one embodiment, the submenu may be a dropdown menu 614 as shown in FIG. 7. By selecting one of the teams in the dropdown 614, the user may be directed to that team's Blast Box (i.e., a Blast Box featuring the rivalry between the selected team and the scheduled opponent). The selected team may appear on one sidebar 604, 606 (FIG. 6) and the database 122 may put that team's opponent on the opposite side. In the illustrated embodiment, the selected team is in the left sidebar 604 and the opponent is in the right sidebar 606.

The featured rivalries displayed in the featured rivalries section 612 of the main navigation panel 608 are pre-selected rivalries between two teams selected by the chat system operator and/or the system database 122. By selecting one of the rivalries in the featured rivalries section 612, the user may be transferred directly to the Blast Box for the selected rivalry, without the need for an intervening dropdown menu. The selected teams may appear on the respective sidebars 604, 606. Featured Blast Box graphics may also be displayed in the “selector” that is located in the center above the Blast Box. Featured Blast Box graphics may only be shown in the “selector” with graphics representing each team along with the date and network on which the event will air when the user is not signed in. When the user is signed in and selects one of the rivalries in the featured rivalry section 612, but has not selected either team (or has both teams) in their myTEAMS list, the user will be asked “Who do you back?” while being displayed a selection box with the names of both teams. After the user makes their selection of which team they support, that team will be placed on the left side of the chat room interface 600 chat area or scrolling text area 416, and the non-selected team is placed on the right side bar 406.

Referring now specifically to FIG. 8, the interface screen 600 is shown in a second mode (e.g., “after sign-in” mode), as may be displayed after a user is signed-in to the chat system. After sign-in, the main navigation panel/selector header 608 may be replaced by a preferred team panel 616 (which may be called a “myTEAMS” panel in some embodiments).

The preferred team panel 616 may display team graphics based on the teams the user chose to follow when first creating an account or subsequently adding teams after an account is created. These user-selected teams on the preferred team panel 616 are termed the preferred team list.

The user may reorder and/or make changes to their preferred team list (e.g., “myTEAMS list”) by clicking the Account Settings button next to the preferred team selector (e.g., “myTEAMS selector”). The user may also add teams to their preferred teams selector by clicking on the “+” sign next to the large team graphic in the far left side of the selector.

For each affiliation group (e.g., sports league), the user may indicate which is their “favorite” team in their preferred teams list (e.g., “myTEAMS list”). Such selected favorite team's icon may follow the user into other team's Blast Boxes by league. However, if the user visits another team's Blast Box that is not their “favorite” but is among the user's preferred teams list (e.g., “myTEAMS list”), the favorite team's icon may not appear, but rather the team that was selected.

As previously described, the Blast Box 602 is the two-sided chat feature in a rivalry context. The team that the user selects from the header main navigation panel 608 (or a submenu thereof), featured navigation section 612, or myTEAMS list 616 will be denoted (e.g., in the database 122) as the team the user chooses to support. The selected team will then appear on the left side of the Blast Box and the team's opponent (as determined by the database 122) will appear on the right.

During a chat session using the chat system 100 with a Blast Box (e.g., 402 or 602), if a first user wishes to reply to a second (specific) user of the Blast Box, the first user may click on the chat message of the second user inside the Blast Box. This will automatically generate an “@username” string (where “@username” is the user name/user ID of the first user) in the first user's text entry field. This feature will help people know who their comments are directed towards and help cause less confusion. In some embodiments, Blast Box comments must be under 255 characters per entry.

In some embodiments, users may leave one Blast Box and enter other Blast Boxes simply by selecting a team found in the main navigation menu 608. Users may also quickly navigate to other teams' Blast Boxes by clicking on the desired teams in the preferred teams list (e.g., “myTEAMS list”) in the preferred teams panel 616.

When a first Blast Box session reaches a certain number of users and starts to fill up, the users may be given an option to go into second Blast Box by activating a room/session button or menu 440. When the second Blast Box reaches its number, a third Blast Box may open up, and so on. Users may switch between any number of Blast Boxes they like until a particular Blast Box reaches a pre-determined maximum number.

Referring to FIGS. 6 and 11, the display area/Blast Box may also include: 1) a mail button 618 (which may be called a “shout out” button in some embodiments) that will allow users to send out emails to inform others (e.g., potential users) about the desirable features of the rivalry chat system; 2) a help button 620 (which may be called a “quickstart” button in some embodiments) that will explain all the features rivalry chat system is capable of; 3) a “full-screen” button 622 that resizes the main display area/Blast Box to fill the entire browser window; and/or 4) a “shrink-screen” button (not shown) may appear in place of the full-screen button when full-screen mode is activated, wherein clicking the shrink-screen button may shrink the display area/Blast Box back to normal size.

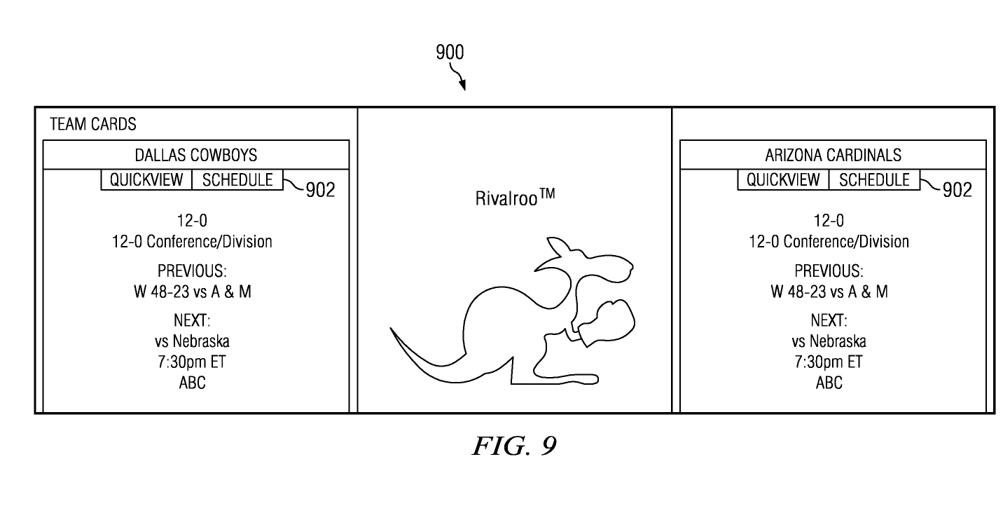

Referring now to FIG. 9 (and also shown in FIG. 6), there is illustrated a team card screen in accordance with another embodiment of the chat system. Team cards 900 are screen panels providing up-to-date information that gives the chat system user a “quickview” of all the important info a fan would like to know. The quickview information is shown by default. In some embodiments, the team card quick view information includes the team record of wins and losses, the teams recent winning or losing streak record, one or more previous game results, and the information about the next scheduled game. The user may also select a schedule tab 902 to show a partial schedule of the upcoming rivalries (e.g., games). There may also be a link below the partial schedule that may take the user to a page that contains the entire schedule for the season or that takes the user to a page or website that sells tickets to the game.

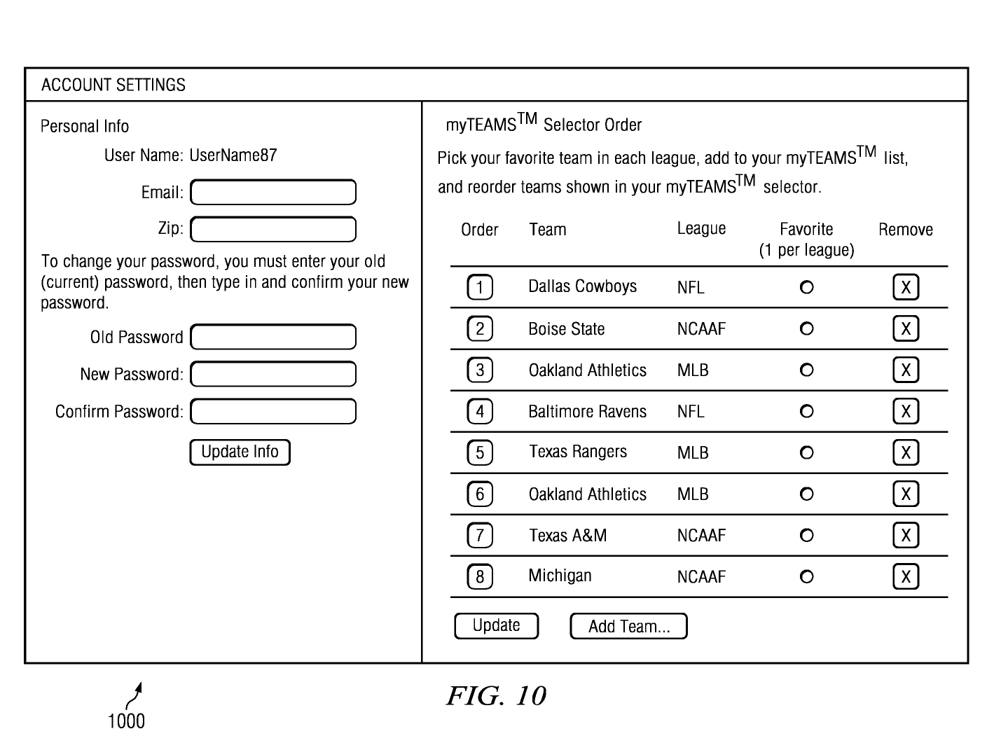

Referring now to FIG. 10, there is illustrated an account settings screen in accordance with another embodiment. The account settings page 1000 may contain a section that allows you to update your personal information such as email address, zip code, and password. Account settings may also allow you to re-order your preferred teams list 616 (e.g., “myTEAMS list”), select or change your favorite team (1 per group/league), add teams to your myTEAMS list, and remove teams from your myTEAMS list.

Referring now to FIGS. 12A, 12B, 13, 14A, 14B and 15, there is illustrated a computer network chat system in accordance with yet another embodiment, including the associated Team Chat application and associated chat interfaces.

Referring first to FIGS. 12A and 12B, there is illustrated a “HOME PAGE” interface 1200 of the system. A header portion 1202 includes a HOME button 1204, a league selection area 1206, a featured rivalry selection area 1208 and a “myTEAMS” (e.g., previously identified teams of interest) selection area 1210. The header portion 1202 is typically displayed in the same location on each page of the chat system site to provide consistent access to the features provided thereon.

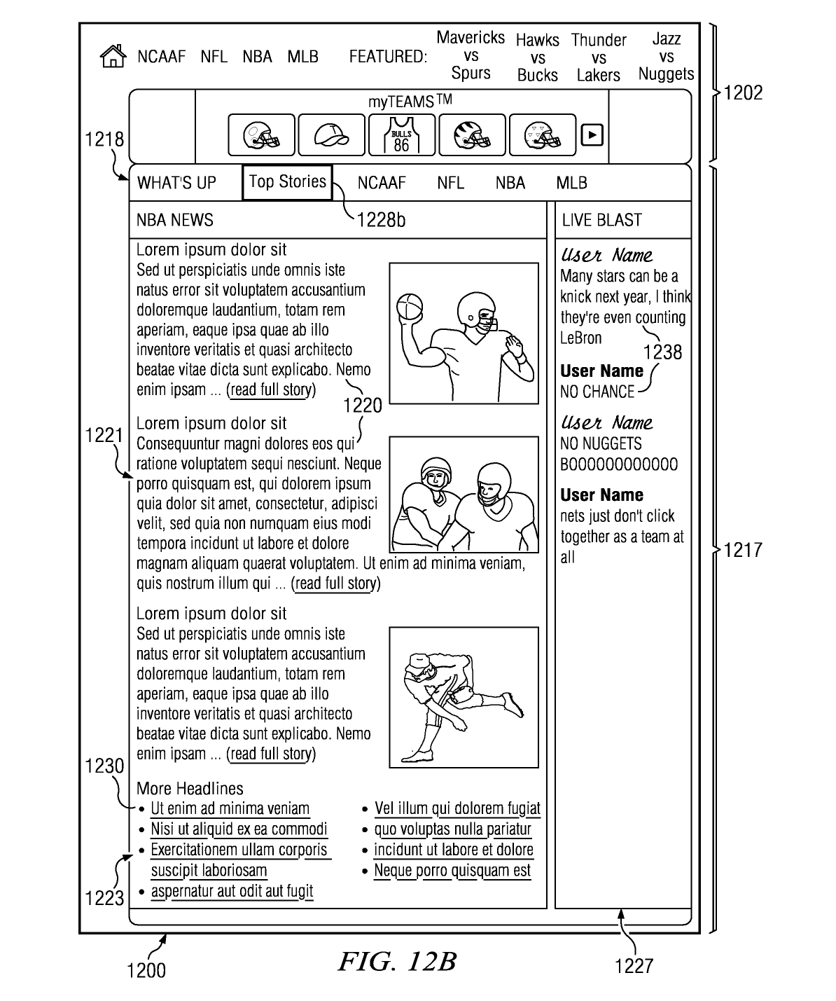

The HOME button 1204, when activated from any page of the chat system, acts as a link to take the user back to the HOME PAGE 1200. The league selection area 1206 may include one or more league buttons 1212. Activating one of the league buttons 1212, either by clicking it or hovering over it, causes a pop-up or drop-down menu (e.g., similar to menu 614 in FIG. 7) to display with a listing of all teams in the league identified by the button. Each team name listed/displayed in this pop-up/drop-down menu acts as a link to the associated chat system web page that displays the Blast Box chat interface (e.g., FIG. 13) for the selected team.

The featured rivalry selection area 1208 may include one or more featured rivalry buttons 1214 associated with “featured” team rivalries pre-selected by the chat system manager. Each featured rivalry button 1214 acts as a link to the associated chat system web page that displays the Blast Box chat interface for the selected featured rivalry. The myTEAMS selection area 1210 may include one or more myTEAMS buttons 1216, each one associated with a team pre-selected by the user, e.g., during the initial registration process or at a subsequent time. Each myTEAMS button 1216 acts as a link to the associated chat system web page that displays the Blast Box chat interface for the selected team. A user may pre-select a plurality of favorite teams during the initial registration process or at a subsequent time. The exemplary Graphic User Interface 1200 may show up to five myTEAMS buttons 1216 at a time. An indicia or arrow may become visible to the user when more than five teams were chosen by the user. When the indicia or arrow (not specifically shown) is clicked or hovered over, additional user selected favorite teams or myTEAMS buttons 1216 may be displayed for the user to select. Favorite teams can be added or removed by a user via an exemplary interface page at any time by navigating to the account settings page 1000 shown in FIG. 10.

The HOME PAGE interface 1200 further includes a multi-purpose portion 1217 and a mode selection area 1218. In the illustrated example, the multi-purpose portion 1217 is disposed below the header portion 1202 on the HOME PAGE 1200, and the mode selection area 1218 is disposed near the top of the multi-purpose portion, however, the relative positions of these elements may be changed in other embodiments. Disposed within the mode selection area 1218 is a plurality of mode/league selection buttons 1228. The mode/league selection buttons 1228 may be labeled with the names of various sports leagues or other rivalry groups, e.g., “NCAAF,” “NFL,” “NBA” and “MLB” and/or with the names of available display modes, e.g., “TOP STORIES” (see FIG. 12B). The content displayed in the multi-purpose portion 1217 depends upon which of the mode/league selection buttons 1228 is activated, as further described herein. The currently active mode/league selection may be indicated by displaying the associated mode/league button 1228 in a contrasting color.

Referring now specifically to FIG. 12A, there is illustrated an example of the HOME PAGE interface 1200 when the active mode/league selection is a sports league, in this example “NBA” indicated by league/mode button 1228a being in a contrasting color. The multi-purpose portion 1217 of the interface 1200 may now include a league article display area 1220, a league headlines area 1222, a league schedule area 1224 and a sample comments area 1226. Activating a mode/league button 1228 associated with a league (e.g., by clicking on the league name) “selects” that league and causes the league article display area 1220, league headlines area 1222, league schedule area 1224 and sample comments area 1226 to be populated with content relevant to the selected league. The league article display area 1220 may display articles including text, graphics and/or videos relating to the selected league. The articles, graphics and/or video in the display area 1220 may be preselected, e.g., by the chat system administrators, served/linked from other sites, or they may be selected in real time, e.g., by automated searches, each time the page is refreshed. The league headlines area 1222 may display headlines 1230 relating to the selected league, where the text of each headline is actually a link to another article relevant to the selected league. Activating one of the headline links 1230 takes the user to the Blast Box Preview (i.e., Headlines) mode for the team that the article is associated within the data base 122. The headlines 1230 may be preselected by the chat system administrators, served/linked from other sites, or they may be selected in real time, e.g., by automated searches, each time the page is refreshed.

Referring still to FIG. 12A, the league schedule area 1224 includes one or more game match-ups 1232 representing upcoming games (i.e., rivalry contests) within the selected league in a schedule form, e.g., sorted by game dates 1234 and game times 1236. Each game match-up 1232 comprises a pair of adjacent team buttons 1233 representing the two teams participating in the scheduled game. Each of the team buttons 1233 acts as a link to the associated chat system web page that displays the Blast Box chat interface (e.g., FIG. 13) for the selected game (match-up). The team buttons 1233 may display team names, team icons, team mascots, team colors or other indicia indicative of the respective teams involved in the associated game. “Hovering” over a team button 1233 may cause the color of nearby text to change from the default color to a color representing the associated team. Activating (e.g., clicking on) one of the team buttons 1233 in a game match-up 1232 indicates the user's support for the selected (i.e., clicked-on) team, and “takes” the user (i.e., changes the system interface) to the Blast Box page corresponding to the relevant game match-up. Once at the Blast Box page (see, e.g., FIG. 13), the user will be added to the list of users supporting the selected (i.e., clicked-on) team. In some embodiments, the selected (supported) team will always be positioned on the same side (e.g., left or right) of the central chat display (e.g., 1310 in FIG. 13). During certain time periods, e.g., during the “off season” for a league, the league schedule area 1224 may not be included in the interface 1200. Under such circumstances, either the league information display area 1220 and/or the league headlines area 1222 may be expanded to occupy some or all of the unused area.

The sample comments area 1226 includes a scrolling display of real-time or near-real-time comments 1238 (i.e., text messages) reproduced from a plurality of Blast Box chat interface pages for games/rivalries hosted on the system. When the active mode/league selection is a sports league, the comments 1238 in the in the sample comments section 1226 may be selected only from Blast Boxes associated with the selected league. The scrolling comments 1238 in the comment area 1226 provide the system user at the HOME PAGE 1200 with a sample of the various chat threads currently underway (e.g., for the league of interest) on other pages (i.e., the Blast Box pages) of the chat system. The text of the comments 1238 may act as a link to the associated chat system web page that displays the Blast Box chat interface where the subject comment was originally entered. By activating (e.g., clicking on) a comment link 1238 of interest, the system user will have convenient and immediate access to the relevant web page (i.e., the relevant Blast Box page) so that the user can respond to the comment of interest.

Referring now specifically to FIG. 12B, there is illustrated an example of the HOME PAGE interface 1200 when the active mode/league selection is not a sports league, but rather is a display mode, in this example the “TOP STORIES” display mode. The selected mode is indicated by league/mode button 1228b (labeled “TOP STORIES”) being shown in a contrasting color. The multi-purpose portion 1217 of the interface 1200 may now include an all-league article display area 1221, an all-league headlines area 1223 and an all-league comments area 1227. The all-league article display area 1221 may comprise a plurality of individual article display areas 1220, each including text, graphics and/or video content populated with content relevant to the all of the leagues/affiliations covered by the chat system. The text, graphic and/or video content of each article display area 1220 in the display area 1221 may be preselected by the chat system administrators, served/linked from other sites, or they may be selected in real time, e.g., by automated searches, each time the page is refreshed. Similarly, the all-league headlines area 1223 may display headlines 1230 relating to all of the leagues/affiliations covered by the chat system, where the text of each headline is actually a link to another article relevant to the selected league. Activating one of the headline links 1230 takes the user to the Blast Box Preview (i.e., Headlines) mode for the team that the article is associated with in the database 122. The headlines 1230 may be preselected by the chat system administrators, served/linked from other sites, or they may be selected in real time, e.g., by automated searches, each time the page is refreshed. The all-league comments area 1227 includes a scrolling display of real-time or near-real-time comments 1238 reproduced from a plurality of Blast Box pages for games/rivalries from all of the active leagues/affiliations hosted on the system.

Referring now to FIG. 13, there is illustrated a “Blast Box” interface 1300 of the chat system. The chat system will typically include one or more different Blast Box pages 1300 for each of the games/rivalry contests identified on the HOME PAGE 1200. The Blast Box portions 1304 are the principal (but not necessarily the only) locations on the chat system where the chat messages in a rivalry context are conducted and displayed.

The Blast Box 1300 may include the previously described header portion 1202, including the HOME button 1204, league selection area 1206, featured rivalry selection area 1208 and “myTEAMS” selection area 1210. The header portion 1202 may further include a team icon 1302 indicating the system user's affiliation with one of the two teams in the relevant rivalry. A mini schedule that indicates upcoming opponents may also be included in the header portion 1202. The mini schedule may show two or more opponents of a user selected favorite team that will be playing the user selected favorite team in the near future. The mini schedule may provide buttons with icons which contain a mini-logo of the opponents team along with a month/day abbreviation of the game days.

The Blast Box interface 1300 further includes a Blast Box portion 1304. In the illustrated example, the Blast Box portion 1304 is disposed below the header portion 1202 on the Blast Box page 1300, however, the relative positions may be changed in other embodiments. With the exceptions of the BLAST BOX tab 1305, PREVIEW tab 1306 and VIDEO tab 1308 (which are further explained below), the Blast Box portion 1304 of the interface page 1300 is substantially similar to the Blast Box previously described in connection with FIGS. 4-11. For example, the Blast Box portion 1304 may include a unified central chat display area 1310 disposed substantially along the centerline of the display, a left sidebar 1312 disposed to the left of the central chat display area and a right sidebar 1314 disposed to the right of the central chat display area. The left sidebar 1312 is associated with users having one team/group affiliation of the rivalry (e.g., Boston) and the right sidebar 1314 is associated with users having the other team/group affiliation of the rivalry (e.g., Cleveland). Each sidebar 1312, 1314 includes a team name area 1316, roster area 1318 and team-specific message area 1320 for its respective team. The respective roster areas 1318 display those users that are currently logged-in for each team/group affiliation. In an embodiment, the text color and/or color theme used for each sidebar 1312, 1314 will be selected to be representative of the team/affiliation associated with that sidebar. The central chat display area 1310 may include a scrolling text display area 1322 for displaying the text messages from the users listed in the sidebars 1312, 1314, a chat message text entry area 1324 and a “SEND” button 1326.

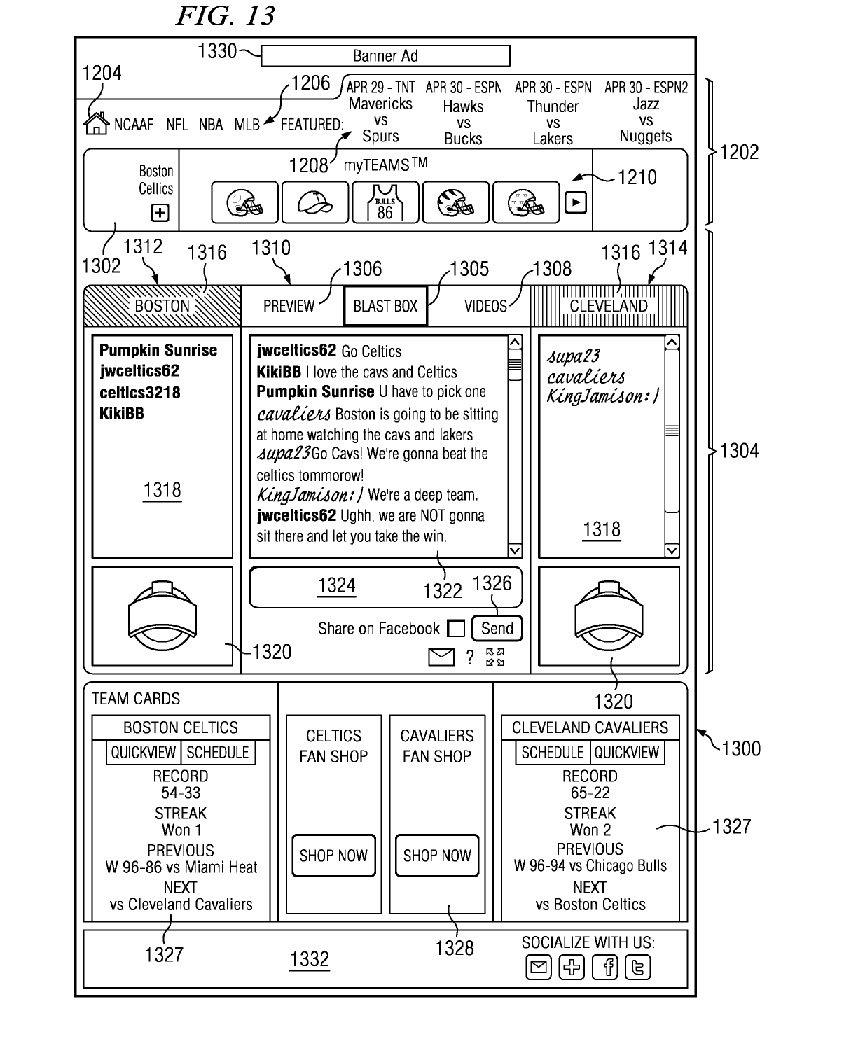

The Blast Box interface page 1300 may further include one or more “team cards” 1327 disposed on the page. Such team cards 1327 may be substantially identical to those previously described in connection with FIG. 9. Team cards 1327 are page areas providing team statistics, team data and/or other information relevant to the associated team/affiliation group, thus providing the chat system user with a convenient source of information likely to be of interest. The team cards 1327 may have one or more control tabs 1329 (FIG. 14A) that control the type of information displayed. Activating the “Quickview” tab 1329 causes the team card 1327 to display statistical information such as win/loss record, streak count, and recent/upcoming game information. Activating the “Schedule” tab 1329 causes the team card 1327 to display a partial schedule of the upcoming games (i.e., rivalry contests). There may also be a link below the partial schedule that may take the user to a page that contains the entire schedule for the season. One of the tab display modes may be set to a default mode if neither tab 1329 is activated, e.g., the Quickview mode is the default in the example shown.

The Blast Box interface page 1300 may further include one or more advertising locations disposed around the visible page. Some such advertising locations are affiliated with the respective team/group, and therefore are disposed on the associated team/group's side of the page. Other such advertising locations, e.g., main advertising display area 1328, upper banner advertisement 1330 and lower banner advertising area 1332 may not be specifically directed to a particular team/affiliation, but may be of interest to users in general. As previously described, e.g., in connection with FIG. 4, the advertising locations 1328, 1330 and 1332 may display fixed/static advertisements or dynamic advertisements. Each advertising location 1328, 1330, 1332, whether featuring static or dynamic advertising content, may include one or more embedded links that, if clicked, redirect the user to other network sites selected by the chat system. It will be understood that in the illustrated system, the upper and lower banner advertisements 1330 and 1332 are completely or partially blank.

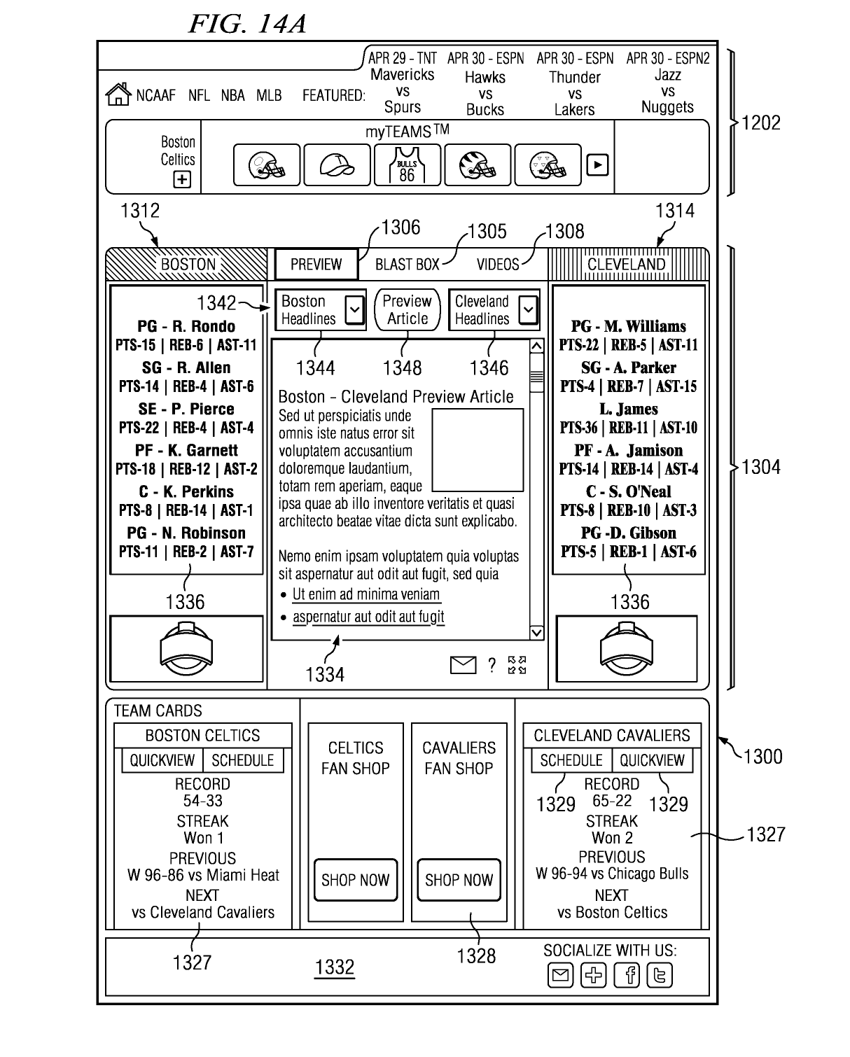

The Blast Box page 1300 illustrated in FIG. 13 shows the configuration that results when the BLAST BOX tab 1305 is activated. Referring now to FIGS. 14A, 14B and 15, activating the other two tabs, i.e., the PREVIEW tab 1306 or the VIDEO tab 1308, changes the visual configuration of the interface page 1300.

Referring now to FIGS. 14A and 14B, the Blast Box page 1300 is shown in an alternate configuration that results when the PREVIEW tab 1306 is activated. In this configuration, the scrolling text area 1322 of the Blast Box interface is replaced with a feature article area 1334 showing an article that is relevant to the selected game, e.g., to the contest itself or to one or both of the teams competing in the relevant game, and the team rosters 1318 are replaced with statistics 1336 (i.e., “stats”) for the respective teams. Disposed adjacent to the article area 1334 is a menu bar 1342 including one or more activatable elements. In this example, the activatable elements comprise a pair of drop-down menus 1344, 1346 and a button 1348. In some embodiments, activating the left drop-down menu 1344 (see FIG. 14B) displays a listing 1350 of articles in support of the team (e.g., 1312) positioned on the left side of the page, activating the right drop-down menu 1346 displays a listing of articles in support of the team (e.g., 1314) positioned on the right side of the page, and activating the center button displays a “neutral” or non-biased article regarding the game, e.g., a game preview. The selected article is then displayed in the article area 1334. The articles populating the article display area 1334 and menu bar 1342 may be written and/or preselected by the chat system administrators, served/linked from other sites, or they may be selected in real time, e.g., by automated searches, each time the page is refreshed.

Referring now to FIG. 15, the Blast Box page 1300 is shown in yet another alternate configuration that results when the VIDEO tab 1308 is activated. In this configuration, the scrolling text area 1322 of the Blast Box interface is replaced with a video playback area 1338 (e.g., a virtual DVD player), and the team rosters 1318 are replaced with thumbnails 1340 for videos relating to the respective teams, e.g., video of an earlier game involving one or both of the teams. The thumbnails 1340 are actually links, which when activated, load the video clip depicted on the thumbnail into the video playback area 1338 such that the user can watch the video using controls 1342. The videos displayed in the area 1338 may be chosen by the chat system administrators, e.g., through the use of search terms that use a third-party API (Application Programming Interface) to search and retrieve video content.

In yet another embodiment of the invention, a team chat plug-in (“plug-in”) is provided for third-party websites to implement aspects of the exemplary chat system 100 via the internet 106 and connect to the exemplary chat server computer 104. An exemplary plug-in may be implemented into third-party websites such that a user of a third-party website will see a graphic user interface similar to an exemplary Blast Box interface 200, 300, 400, 600, or 1300. It is understood that visual, functional and graphic differences may exist between a third-party plug-in view of an exemplary Blast Box interface and an exemplary Blast Box interface viewed directly from a home website. Incorporation of an exemplary plug-in to numerous third-party websites creates a unique tool that allows users from websites all over the internet to access a same or similar dual-sided, rivalry based, chat system wherein a user selects a team or side of a rivalry, as well as provides a screen name and other information, in order to participate with other users in a rivalry dual-sided chat experience with others who are actively discussing two sides of a same or similar topic.

In one embodiment, the plug-in enables a Graphic User Interface experience, which aggregates a rivalry or debate team style chat experience across a plethora of websites on the internet. In additional embodiments, the plug-in could be customized or modified to suit a topic having two, three, four or more view points, stances, or rival aspects wherein users must log in and indicate the view point or stance they are taking on the topic prior to participating in a multi-view point chat discussion of a selected topic.

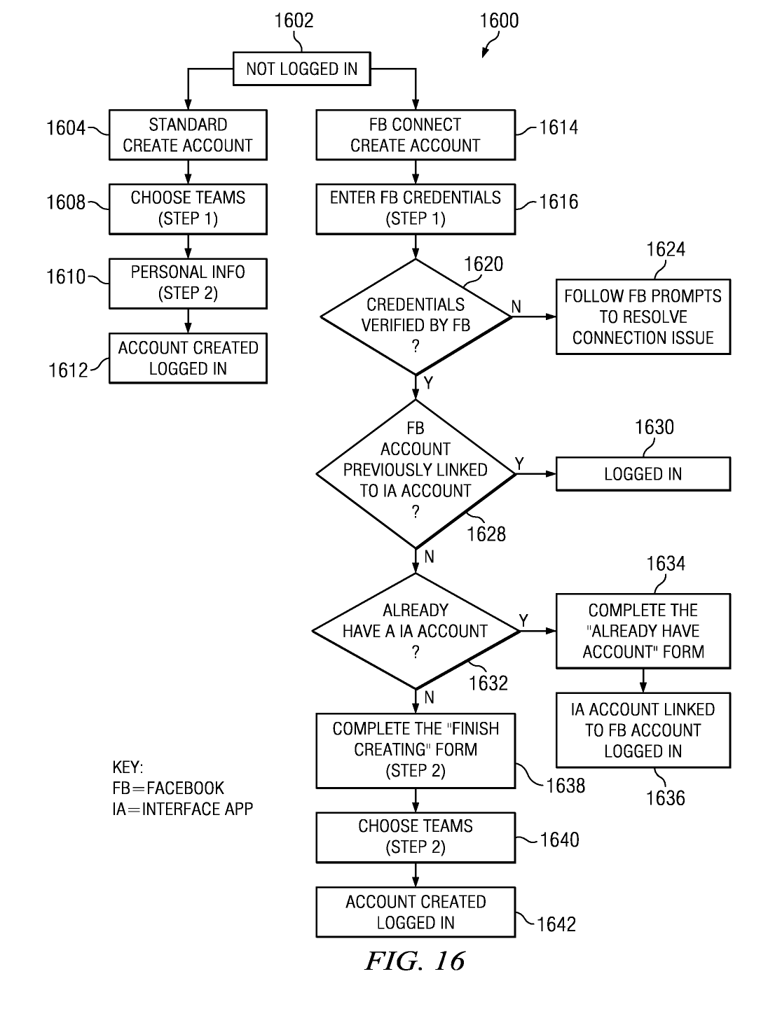

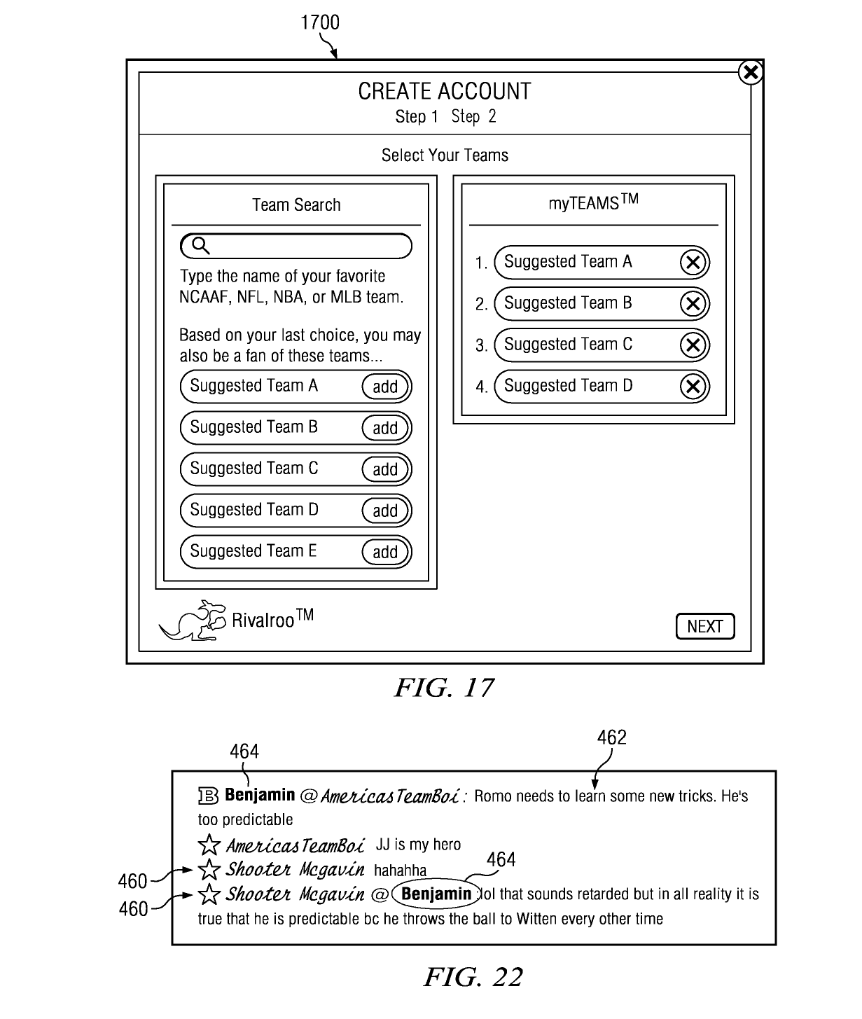

Prior to a user being able to participate in an ongoing rivalry or multi-view topic, the user must be viewing an exemplary plug-in interface on the third-party website. The user's participation may begin by selecting or clicking on the “Got something to say?” or similar image link, or a login button provided on the plug-ins Blast Box interface screen, which may be similar to the “Got something to say?” graphic for a team and the “join the Blast Box now” button 420 seen in FIG. 5. When a got something to say button or login button is selected, the user on the third-party site will be presented with a login/create account modal interface similar to the modal 1800 shown in FIG. 18. An exemplary login/create account modal interface will allow a user to enter and participate in the ongoing rivalry or multi-view point chat using a preexisting user name and password. If a preexisting user name and password for the user do not exist, the user may fill out and submit their email address, selected password and screen name to establish a login to an exemplary Blast Box interface via a plug-in on a third-party website. In some embodiments, a user can login via an account obtained via yet another third-party website, such as facebook, twitter, gmail, etc. by clicking on or selecting a provided connect button 1901 associated with the other third-party web site shown in FIG. 19.

In some embodiments, a plug-in installed on a third-party website is preassigned a particular team or topic view point. For example, assume an exemplary plug-in resides on the www.angelswin.com website. Such a plug-in may be preassigned the MLB (Major League Baseball) team of the Los Angeles Angels. When a user of the www.angelswin.com website views the exemplary plug-in interface, the user will view the exemplary Blast Box chat interface as if they are an Angels fan such that the Angels team is placed on the left side bar of the Blast Box interface. The rival team (or opposing view if the topic is a debate or discussion style chat) may be placed on the right side bar of the Blast Box interface in a manner similar to that shown in FIG. 6.

One of ordinary skill in the art would understand that an exemplary Blast Box interface 200, 300, 400, 600, 1200 or 1300 may be configured in various ways. An exemplary basic Blast Box interface, method and exemplary application comprises at least one mode of operation that displays an interface conversation tool which allows users to chat in an sports rivalry or multi-sided opinion context that gives a user/viewer immediate information as to the perspective, point of view or team that other users/participants support. For example, embodiments may allow users to select and side with one of a plurality of candidates running for an office. Another example may be using the exemplary Blast Box to provide a place to discuss a heated topic such as abortion while allowing users to log in and chat by indicating whether they are for, against, or in favor of a second-trimester rule. When more than two view points are taken on the topic, additional side bars may be added about the unified central chat display area 1310.

It should be understood that the names of the various modes (selectable or viewable areas) associated with an exemplary Blast Box interface may be changed. One of ordinary skill in the art will understand the function of each mode is what is important rather than the actual naming convention used for a particular mode or interface operation.

Referring again to FIG. 13 as well as FIG. 1, an exemplary Blast Box interface 1300 is a website application stored and operated on a chat server computer in conjunction with a database 122 and a chat room application 102. It uses an exemplary chat room application 102 as its core functionality, but may also use several other features and applications as part of this functionality, all of which work with and may supplement the Blast Box interface chat room application 102. For example, as discussed above and as will be discussed in additional detail below, some of these features that supplement the Blast Box interface chat room application 102 may include a myTEAMS list, featured match ups/rivalries, featured selector, myTEAMS selector, team cards, various embodiments of schedules, various embodiments of related articles or publications, statistical information, registered user account settings, and facebook or other third-party connection/login integration.

In the context of sports teams, an exemplary Blast Box interface chat room application operates by pairing two teams. Each team has the ability to be paired with another team in the same sports league. Actual web pages for each pair of teams do not normally exist in an exemplary Blast Box interface chat application. Instead, a web page displaying a unified central chat display area 1310 along with a left side bar 1312 and right side bar 1314 are presented to the end user viewing the Blast Box interface 1300 as if an actual web page for each pair of teams did exist. This is accomplished using a web development and programming method called AJAX (Asynchronous Javascript And Xml). AJAX is a group of interrelated web development techniques used on the client-side to create interactive web applications. With AJAX, web applications can retrieve data from the server asynchronously in the background without interfering with the display and behavior of the existing page. Embodiments utilize AJAX via novel programming, which provides the ability to segregate the display of participating chat users into two or more groups wherein each group has a unique visual characteristic or identifier such that chat entries into the unified central chat display area 1310 or first and second side 204, 206 (see FIGS. 2, 11 and 13) have visual attributes indicting to a viewer the team or faction that the chat participant is associated with. Thus, aspects of the Blast Box interface unified central chat area 1310, left side bar 1312, right side bar 1314 and/or an additional 3^{rd}, 4^{th} or 5th side bar (not specifically shown) can each be asynchronously updated in real time or near real time as user's enter, chat and exit the exemplary chat room or area.

Even though a different web page for each pair of teams does not actually exist on a server, a user of an exemplary Blast Box interface chat application will view an exemplary Blast Box interface 1300 as if such web pages actually exist. Meanwhile, an exemplary embodiment provides each team or opinion/faction its own URL that can be directly navigated to by a user. For simplification and understanding herein each team or opinion/faction will be referred to as having its own “page.” With the understanding that each team has its own page, one can understand that each team or opinion/faction to which a page currently belongs is the “current team,” and is the team that is assumed that the user is currently supporting, backing, rooting for, sides with.

While each team or opinion/faction has its own page, each page can be better understood if it is matched up with one of several possible “match ups” which can also be represented on each page. A “match up” is any combination of team vs. team scenario, opinion vs. opinion scenario or faction vs. faction scenario. Such scenarios generally involve two teams in the same league, two opinions associated with a same problem, two factions associated with a related situation, etc. With respect to teams, it may be the NBA teams of Boston vs. Orlando. With respect to opinions it may be groups of people in favor of abortion and against abortion. With respect to factions it may be groups favoring a particular candidate for office vs. another or multiple other candidates for office prior to an election. It should be understood that in some embodiments two or more sports entities, opinions or factions are also possible. For example, with respect to teams, users may be rooting for certain individuals among a plurality of gymnasts or sprinters in an Olympic competition. With respect to opinions, individuals may take various sides or solutions to a given topic such as health care or health reform. With respect to factions in any given election or pre-election there may be a plurality of candidates whom users may choose from to root for or side with. When a user selects via an exemplary Blast Box interface chat application, a team's URL page, for example Team A, is displayed to the user via the exemplary Blast Box interface application, which navigates to the Team A page. The Blast Box interface application checks the schedule for Team A, via the database 122, to determine the next team that Team A is scheduled to play. Assuming Team A is scheduled to play Team B next, Team B is set up as the default current opponent for the Blast Box interface page 1300 that the user is provided to view. If, for example, the user selected a political candidate for election faction, the exemplary Blast Box interface application will determine, via the database 122, whether the upcoming election is a primary election or a final election to set up the default current opponent(s) for the page to be viewed by the user. The Blast Box interface ultimately viewed by the user provides a conversation/chat tool that allows each user to chat in a rivalry context while giving immediate visual information as to which user supports which team, opinion or faction.

Generally, there are two or more user lists containing the screen names of the users that support each team, opinion or faction. If a user/viewer is not logged-in, he is limited to only viewing the Blast Box interface 1300 and can not participate in the chat conversation. The placement of the teams, opinions or factions about the Blast Box central chat area 1310 is arbitrary. As users enter their chat messages, the messages can not be seen by other users or viewers of the Blast Box interface. After the user's message has been entered and edited by the user, the user may select or press the send or submit button 1326 such that the entry is displayed in the unified central chat display area 1310. Each user entered message is preceded by a user name or screen name, displayed in the team's color and with the team's logo preceding the user's name. This user name coding technique lets all viewers and users immediately know which team the chat entry author is supporting. It is understood that the chat entries may use different fonts, underlining or other indicia to indicate to viewers the chat entry author's team, opinion or faction association.

In some embodiments of the invention, most of the Blast Box interface features are available to a user who is visiting the site, but not logged-in. Logging or signing into the Blast Box interface application provides a user with some additional functionality. Once logged-in, the user may be provided with an ability to a) add or remove teams from their myTEAMS list; b) identify themselves with a particular team in a team vs. team match up; c) take part in the chat conversation of any Blast Box interface; or d) simultaneously post messages in a Blast Box and on their facebook wall or other third-party social network website.

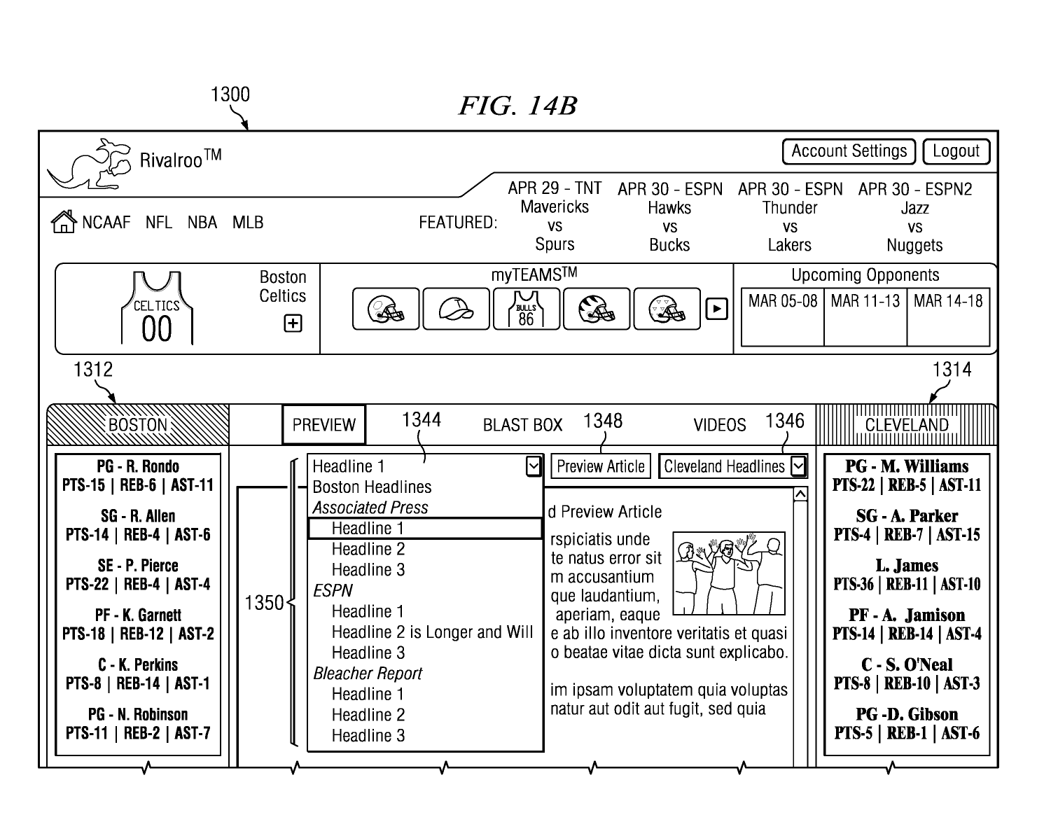

Referring now to FIGS. 16, 17 and 18 a user can create an account immediately accessed to an exemplary Blast Box interface application in at least one of a few ways. The user can create a Blast Box interface account by clicking or selecting a create account button (or a reasonable facsimile thereof) displayed on a Blast Box interface page, or by clicking the “Got something to say? Say it!” image-link for a team 420, that appears in, for example, the chat room interface 400 depicted in FIG. 5 and step 1604 of FIG. 16. Clicking either of these buttons activates a series of modal pop-ups. Modals refer to the common effect on web sites where a box containing related content appears over the top of the main content, making the main content appear as if it is in the background.

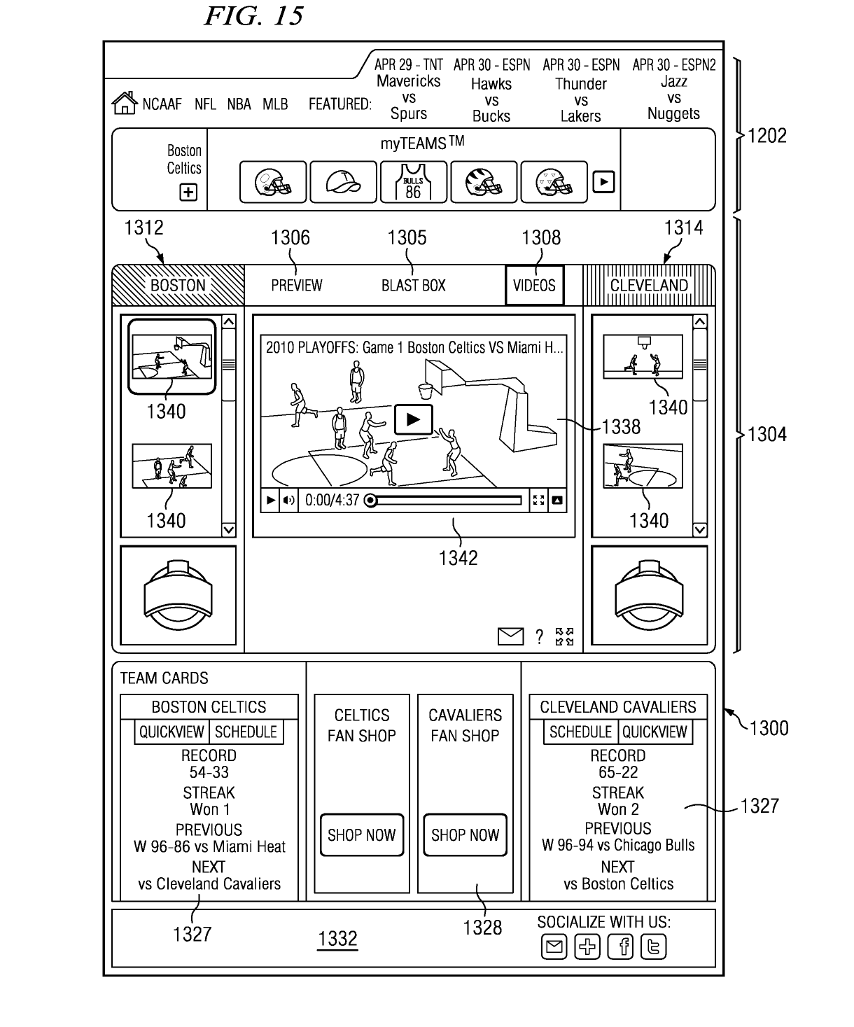

Referring to FIGS. 16 and 17, a first modal 1700 is displayed which enables the user to select up to a certain number of teams 1608. In some embodiments a modal display 1700 may be two boxes, side by side. There is a team search box and a myTEAMS box. The user may utilize the team search box to search for teams and then add them to the myTEAMS box.

In some embodiments the method known as predictive text that may be provided in an exemplary application to assist the user in selecting teams. A user may start to type the name of a team into the team search entry box while, at the same time, a database look up occurs and displays all possible matches below the user's text input. This technique allows the user to select any of the matches. Once selected, the selected team then appears in the myTEAMS box. In additional embodiments, after a selection is made from the predictive text dropdown (not specifically shown) an additional list of suggested teams appears below the search input. The suggested results are determined by one or both of the following: a) other teams that are in close geographical proximity to one another, as determined by application programmers or b) a database look up that shows what teams past users have chosen after choosing the initial team that the user selected.

The user may then press the “add” button appearing next to any suggested team name to add that team to the myTEAMS list or the user may choose to ignore the suggestions and type a new team name in the search input, which starts the process over.

Once the user is satisfied with the selected teams, the user may press the “next” button to move on to step two 1610 of the create a new account process. At step two 1610 of the create a new account process some personal user information may be collected. FIG. 18 depicts an exemplary modal 1800 that may be used to collect some personal information from the user. Such information to be collected may include a user's email address, user created password, user name or screen name, user zip code and perhaps a confirmation of the user's acceptance of the chat room interface application terms of use or service.

In some embodiments, another method of signing or logging in to an exemplary Blast Box chat application may be available. Facebook, as well as other social media web sites such as google, yahoo, myspace, and others are popular social media web sites that release their API (Application Programming Interface) to enable programmers of other web sites to interface aspects of a social media web site, such as facebook, onto their own web site. An exemplary Blast Box or chat room interface application may incorporate a part of the API known as “Facebook Connect,” which allows an exemplary chat room Blast Box interface application to make use of a user or potential user's preexisting facebook login and to share information with facebook or other third-party social network applications found on the internet. By using a third-party social network login API (such as Facebook Connect) a user or potential user does not have to create a new or unique user name and password to log or sign into an exemplary Blast Box chat room interface application. Furthermore, by using a third-party social network login API, a user of an exemplary Blast Box chat room interface application may simultaneously post messages to both the Blast Box and their social network web site.

Referring to FIG. 16, at step 1614, the user makes a decision to log in to an exemplary Blast Box chat room interface application or plug-in via a Facebook (or other third-party API that allows the utilization of a login for another web site). At step 1616 the user clicks on the Facebook Connect button provided on the chat room interface page of an exemplary embodiment or on a Blast Box page generated by a plug-in found on a third-party's web site. The Facebook Connect button 1901 may have a dual purpose being 1) to allow existing users to log into the web site or to enable new users to create a new account login. At step 1616 and in response to the user selecting or clicking on the facebook connect button a pop-up window or modal containing a login page from facebook.com is displayed to the user. The user follows the prompts in the pop-up login page by entering his email/user name and facebook password. Next, the user will enter or press a connect button on the login pop-up. At step 1620 the user entered credentials are verified by the facebook or other web site login application. If there is a problem with what was entered by the user, at step 1624 facebook will prompt the user to resolve the login issue. If the credentials are verified then at step 1628 the facebook or third-party login application will determine whether or not this user has previously linked to the Blast Box chat room interface application via this facebook or other third-party login application. If the answer is yes, then at step 1630 the user is logged into both the facebook application (the third-party login application) as well as an exemplary Blast Box chat room interface application and web site. Conversely, if the user had not used this facebook or third-party login account to link with an exemplary Blast Box chat room interface application then the method proceeds to step 1632. At step 1632 the user is deemed to have logged into the facebook or third-party application and is asked whether the user already has an account with an exemplary Blast Box chat room interface application. If the user responds that he does already have an account, then at step 1634 a modal similar to that shown in FIG. 19 may be displayed and the user may complete the “already have an account” portion of the modal. Once completed at step 1636, an exemplary Blast Box chat room interface application links the preexisting Blast Box chat room interface login information with the facebook or other third-party login application and then logs the user in.

If, at step 1632, the user does not already have an existing Blast Box chat room interface account, then at step 1638 the modal of FIG. 19 may be displayed which requests the user to create a new Blast Box chat room interface account by entering a user name and zip code and/or other information as well as to accept the terms and conditions of an exemplary chat room interface service. At this time, the login information used for both the facebook account and an exemplary chat room interface application account may be the same. Furthermore, the two accounts will be linked thereby giving the user an ability to post messages to both his social network application as well as being able to participate in an exemplary chat room interface. At step 1640 the user is provided the modal 1700 of FIG. 17 wherein he can search and choose favorite teams in a similar fashion as described with respect to step 1608 above. At step 1642, the user account is created in the exemplary Blast Box chat room interface application and the user has access to the various user accessible functionalities described herein.

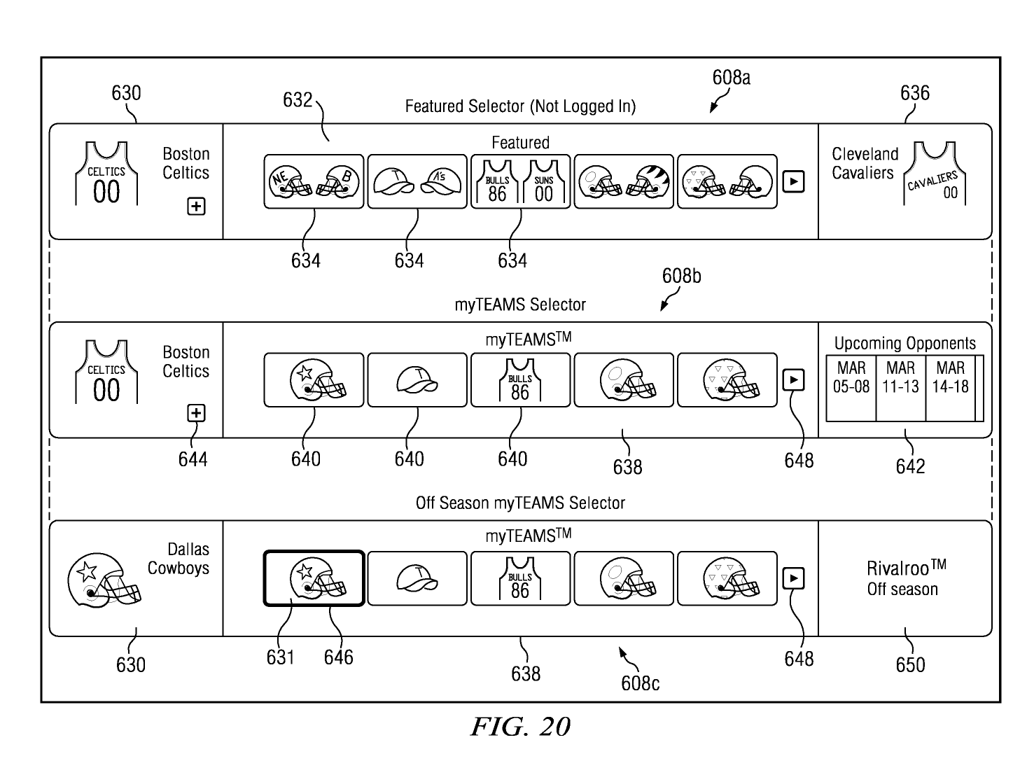

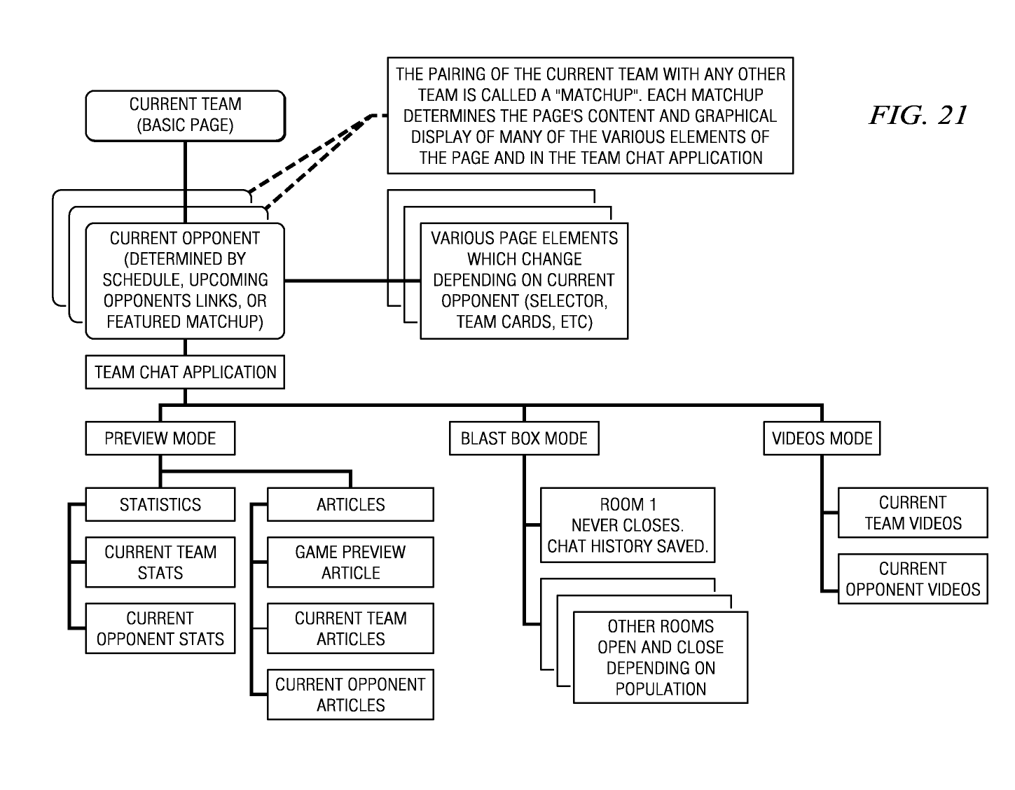

Referring now to FIGS. 11 and 22, there may be times when a user who is logged-in and participating in a Blast Box chat where the user may wish to direct a comment to another user's comment within a scrolling text area 416. Embodiments of the present invention contain a useful user interface function that allows a user to quickly direct a comment to another user's comment within the Blast Box chat area with a single click. When a first user 460 clicks on a second user's comment 462, the chat message that is input by the first user 460 in the text entry area 436 will be populated with an “@username 464” indicating that the first user 460 is commenting at the second user's 464 comment 462. The message typed by the first user using the “@username” function (wherein the user name is replaced with the screen name 464 of the clicked user's message 462. The message can then be typed by the first user 460 until complete. When the @username message is submitted via the send button 438, the message will show up in the chat area 416 with the “@username” text in the color of the submitting user's team. In the example shown in FIG. 21, we can see that Benjamin 464 used the @username function to direct a comment toward Americasteamboi, and that shootermcgavin 460 directed a comment toward Benjamin 464. The colored user names and team logos also make it easy to see that Benjamin 464 is a fan of a first team and that shootermcgavin 460 and Americasteamboi are both fans of a second team.

Referring now to FIG. 21, an organizational chart is provided, which summarizes an exemplary chat room interface in accordance with various embodiments of the invention. For example, an exemplary chat room interface page comprises a current team page 700 along with the current opponent 702 or upcoming rival as determined by a schedule or featured match up. If logged-in the team chat application or Blast Box 704 is depicted on the exemplary chat room interface page. The team chat application 704 may be operating in one of three modes. The first mode being the Blast Box mode 706. The other two modes being the preview mode 708 or the video mode 710. In FIG. 21 and below each of the three modes Blast Box mode 706, preview mode 708 and video mode 710, exemplary other functional interface elements that may be displayed and depicted for the user to view and/or interact with.

In Blast Box mode 706, a Blast Box in the central chat display area 602 may be opened in a first room as depicted underneath the text entry area 436. For example, in FIG. 6 it indicates that there is only one room opened with 32 people in the room 440. Additional rooms may open or close depending upon the number of users participating in a particular team-rivalry match up.

If in preview mode 708 (see also FIG. 14A), the statistics of the current team and the current opponent teams may be displayed. Furthermore, articles relating to the current team and/or the opposing team may be available in the form of game preview articles, current team related articles and current opponent team related articles.

When in the third mode, video mode 710 (refer also to FIG. 14B), current team videos or current opponent team videos may be made available for the user to view at their leisure via the exemplary interface application.

It will be appreciated by those skilled in the art having the benefit of this disclosure that this computer network chat system for display of text and video in a rivalry context provides a computer network chat system for displaying text and video in a rivalry context. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A chat system for a computer network having a plurality of users, at least some of the users having a first of two rival affiliations and at least some of the other users having a second of the two rival affiliations, the chat system comprising:
a chat system room interface including a central chat display area flanked on either side by two lists of users identifying themselves in support of one of the two sides of a rivalry;
wherein, once a user is logged in and identifies which team the user supports, the user and other users affiliated with that team are represented on one side of the central chat display area, and the users affiliated with the rival team are represented on the other side of the central chat display area;
wherein users cannot participate in the chat until they log in and identify which side of the rivalry they support; and
wherein if a user is not logged in, the user cannot participate in the chat, but the central chat display area is still visible and updated to the user.

2. A chat system in accordance with claim 1, further comprising an advertising server connected to the computer network, the advertising server providing advertising content for display on selected areas of the chat room interface by the chat room application.

3. A chat system for a computer network having a plurality of users, at least some of the users having a first of two rival affiliations and at least some of the other users having a second of the two rival affiliations, the chat system comprising:
a chat room application running on a chat server computer connected to the computer network;
the chat room application configured to produce a chat room interface on the display of each of the plurality of users accessing the chat room site;
the chat room interface including a multi channel simultaneous display area including a first channel showing a text chat conversation among users having the first of the two rival affiliations and a second channel showing a text chat conversation among users having the second of the two rival affiliations; and
wherein the chat room application allows all users accessing the site to simultaneously view the first and second channels, but only users logged in as having the first of the two rival affiliations can input text on the first channel, and only users logged in as having the second of the two rival affiliations can input text on the second channel.

4. A chat system in accordance with claim 3, further comprising an advertising server connected to the computer network, the advertising server providing advertising content for display on selected areas of the chat room interface by the chat room application.

5. A chat system for a computer network having a plurality of users, at least some of the users having a first of multi rival affiliations and at least some of the other users having a second of the multi rival affiliations, the chat system comprising:
a chat room application running on a chat server computer connected to the computer network;
the chat room application configured to produce a chat room interface on the display of each of the plurality of users accessing the chat room site;
the chat room interface including a multi channel simultaneous display area including a first channel showing a text chat conversation among users having the first of the multi rival affiliations and a second channel showing a text chat conversation among users having the second of the multi rival affiliations; and
wherein the chat room application allows all users accessing the site to simultaneously view the first and second channels, but only users logged in as having the first of the multi rival affiliations can input text on the first channel, and only users logged in as having the second of the multi rival affiliations can input text on the second channel.

6. A chat system in accordance with claim 5, further comprising an advertising server connected to the computer network, the advertising server providing advertising content for display on selected areas of the chat room interface by the chat room application.

7. A chat system for a computer network having a plurality of users, at least some of the users having a first of multi rival affiliations and at least some of the other users having a second of the multi rival affiliations, the chat system comprising:
a chat system room interface including a central chat display area flanked on either side by multi lists of users identifying themselves in support of one of the multi sides of a rivalry;
wherein, once a user is logged in and identifies which team they support, the user and other users affiliated with that team are represented on one side of the central chat display area, and the users affiliated with rival teams represented on the other side of the central chat display area;
wherein users cannot participate in the chat until they log in and identify which side of the rivalry they support; and
wherein if a user is not logged in, the user cannot participate in the chat, but the central chat display area is still visible and updated to the user.

8. A chat system in accordance with claim 7, further comprising an advertising server connected to the computer network, the advertising server providing advertising content for display on selected areas of the chat room interface by the chat room application.

9. A chat system in accordance with claim 7, further comprising:
a preview mode interface that when selected displays textual information about the teams; and
a video mode interface, that when selected displays video clips associated with the team.

10. On a computer network chat system for a plurality of users, a rivalry chat interface page comprising:
a central chat display;
a first list of users who have identified themselves in support of a first side of a multi sided rivalry;
a second list of users who have identified themselves in support of a second side of a multi sided rivalry; and
means for visually indicating which side of the multi sided rivalry each chat entry in the central chat display is identified with.
